(19) United States
(12) Patent Application Publication
(10) Pub. No.: US 2017/0235435 A1
(43) Pub. Date: Aug. 17, 2017

(54) ELECTRONIC DEVICE AND METHOD OF APPLICATION DATA DISPLAY THEREFOR

(71) Applicant: Samsung Electronics Co., Ltd., Suwon-si (KR)

(72) Inventors: Jungjoo SOHN, Seoul (KR); Jaeseok MYUNG, Siheung-si (KR); Sohmin AHN, Yongin-si (KR); Youngkyu JIN, Seoul (KR)

(21) Appl. No.: 15/429,815

(22) Filed: Feb. 10, 2017

(30) Foreign Application Priority Data
Feb. 16, 2016 (KR) 10-2016-0017749

(51) Int. Cl. G06F 3/0481; G06F 9/44; H04N 5/44

(52) U.S. Cl. CPC G06F 3/0481; H04N 5/44; G06F 9/4443; G06F 2203/04803

(57) ABSTRACT

An electronic device and a method of application data display therefor are provided. The electronic device includes a transceiver, a display, and one or more processor. The one or more processor may receive, from an external device, an application display request for displaying a window for an application associated with the external device, determine, upon reception of the application display request, a designated region of the screen to be used for a window presenting a mirrored screen image of the application, and display at least one application window in the remaining region of the screen identified after determining the region for a mirrored screen image.

### CROSS-REFERENCE TO RELATED APPLICATION(S)

This application claims the benefit under 35 U.S.C. §119(a) of a Korean patent application filed on Feb. 16, 2016 in the Korean Intellectual Property Office and assigned Serial number 10-2016-0017749, the entire disclosure of which is hereby incorporated by reference.

### TECHNICAL FIELD

The present disclosure relates to an electronic device and method of application data display therefor. More particularly, the present disclosure relates to a method that enables multiple electronic devices to exchange and display application data.

### BACKGROUND

With advances in communication technologies, electronic devices supporting various functions have become a necessity of modern life. Electronic devices have evolved into multimedia communication appliances that can provide voice call services, data transmission services, and other supplementary services. For example, an electronic device may receive a broadcast or multicast signal to play back a video or television (TV) program. The electronic device may also send data to another electronic device through wired or wireless communication such as Bluetooth (BT) or third generation (3G) mobile communication.

A user may wish that content displayed on a first electronic device is also displayed on a second electronic device. In this case, the first electronic device may be connected with the second electronic device, and the second electronic device may receive and display the content displayed on the first electronic device. Here, the second electronic device may scale up or scale down the content data before display in consideration of display capabilities of the first and second electronic devices such as screen size and resolution. When the first and second electronic devices have different screen sizes, the screen of the second electronic device may be not fully utilized for image display, leaving an unused region in the screen. Such an unused screen region may lower usability of applications and cause unnecessary power consumption.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device and a method of application data display therefor that can address the above-mentioned problem.

In accordance with an aspect of the present disclosure, an electronic device is provided. The electronic device includes a transceiver or a communication module, a display or a display module, and one or more processor. The one or more processor may be configured to receive, from an external device, an application display request for displaying a window for an application associated with the external device, determine, upon the receiving of the application display request, a designated region of a screen to be used for a window presenting a mirrored screen image of the application on the display, and display at least one application window in a remaining region of the screen identified after the determining of the designated region of the screen to be used for the window presenting the mirrored screen image of the application.

In accordance with another aspect of the present disclosure, an electronic device is provided. The electronic device includes a transceiver or a communication module, a display or a display module, and one or more processor. The one or more processor may be configured to perform a process of receiving an input signal for selecting a region of a screen of an external device to be used for displaying an application window associated with the electronic device, determine an arrangement of application windows in a remaining region of the screen of the external device, and control the transceiver to send, on a basis of the received input signal and the determined arrangement of the application windows, an application display request to the external device.

In accordance with another aspect of the present disclosure, a method of displaying an application for an electronic device is provided. The method includes receiving, from an external device, an application display request for displaying a window for an application associated with the external device, determining, upon the receiving of the application display request, a designated region of a screen to be used for a window presenting a mirrored screen image of the application, and displaying at least one application window in a remaining region of the screen identified after the determining of the designated region of the screen to be used for the window presenting the mirrored screen image of the application.

In accordance with another aspect of the present disclosure, a method of application display for an electronic device is provided. The method includes receiving an input signal for selecting a region of a screen of an external device to be used for displaying an application window associated with the electronic device, determining an arrangement of application windows in a remaining region of the screen of the external device, and sending, on a basis of the received input signal and the determined arrangement of the application window, an application display request to the external device.

In a feature of the present disclosure, the various proposed apparatuses and methods enable the electronic device to display application data in the remaining region of the screen, providing more information to the user and reducing unnecessary power consumption.

In addition, the various proposed apparatuses and methods enable application data displayed on the electronic device to be controlled not only via the electronic device but also via an external device, increasing user convenience.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including electronic devices according to various embodiments of the present disclosure;

FIG. 2 is a block diagram of an electronic device according to various embodiments of the present disclosure;

FIG. 3 is a block diagram of a program module according to various embodiments of the present disclosure;

FIG. 4 is a block diagram of electronic devices according to various embodiments of the present disclosure;

FIG. 5 illustrates examples of electronic devices according to various embodiments of the present disclosure;

FIGS. 6A to 6G are illustrations of application display on electronic devices according to various embodiments of the present disclosure;

FIGS. 7A and 7B are illustrations of application display on an electronic device according to various embodiments of the present disclosure;

FIGS. 8A to 8D are illustrations of application display on an electronic device according to various embodiments of the present disclosure;

FIG. 9 illustrates application display on an electronic device according to various embodiments of the present disclosure;

FIG. 10 illustrates application display on an electronic device according to various embodiments of the present disclosure;

FIGS. 11A to 11E are illustrations of application display on an electronic device according to various embodiments of the present disclosure;

FIGS. 12A and 12B illustrate application display on an electronic device according to various embodiments of the present disclosure;

FIGS. 13A to 13C are illustrations of application display on electronic devices according to various embodiments of the present disclosure;

FIGS. 14A and 14B are illustrations of application display on electronic devices according to various embodiments of the present disclosure;

FIG. 15 illustrates application display on an electronic device according to various embodiments of the present disclosure;

FIG. 16 is a sequence diagram illustrating application display between electronic devices according to various embodiments of the present disclosure;

FIG. 17 is a flowchart for application display on an electronic device according to various embodiments of the present disclosure; and

FIG. 18 is a flowchart for application display on an electronic device according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An expression “comprising” or “may comprise” used in the present disclosure indicates presence of a corresponding function, operation, or element and does not limit additional at least one function, operation, or element. Further, in the present disclosure, a term “comprise” or “have” indicates presence of a characteristic, numeral, operation, element, component, or combination thereof described in a specification and does not exclude presence or addition of at least one other characteristic, numeral, operation, element, component, or combination thereof.

In the present disclosure, an expression “or” includes any combination or the entire combination of together listed words. For example, “A or B” may include A, B, or A and B.

An expression of a first and a second in the present disclosure may represent various elements of the present disclosure, but do not limit corresponding elements. For example, the expression does not limit order and/or importance of corresponding elements. The expression may be used for distinguishing one element from another element. For example, both a first user device and a second user device are user devices and represent different user devices. For example, a first constituent element may be referred to as a second constituent element without deviating from the scope of the present disclosure, and similarly, a second constituent element may be referred to as a first constituent element.

When it is described that an element is “coupled” to another element, the element may be “directly coupled” to the other element or “electrically coupled” to the other element through a third element. However, when it is described that an element is “directly coupled” to another element, no element may exist between the element and the other element.

Unless differently defined, entire terms including a technical term and a scientific term used here have the same meaning as a meaning that may be generally understood by a person of common skill in the art. It should be analyzed that generally using terms defined in a dictionary have a meaning corresponding to that of a context of related technology and are not analyzed as an ideal or excessively formal meaning unless explicitly defined.

In this disclosure, an electronic device may be a device that involves a communication function. For example, an electronic device may be a smart phone, a tablet personal computer (PC), a mobile phone, a video phone, an e-book reader, a desktop PC, a laptop PC, a netbook computer, a personal digital assistant (PDA), a portable multimedia player (PMP), a Moving Picture Experts Group phase 1 or phase 2 (MPEG-1 or MPEG-2) audio layer 3 (MP3) player, a portable medical device, a digital camera, or a wearable device (e.g., a head-mounted device (HMD) such as electronic glasses, electronic clothes, an electronic bracelet, an electronic necklace, an electronic appcessory, or a smart watch).

According to various embodiments of the present disclosure, an electronic device may be a smart home appliance that involves a communication function. For example, an electronic device may be a television (TV), a digital versatile disc (DVD) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame.

According to various embodiment of the present disclosure s, an electronic device may be a medical device (e.g., magnetic resonance angiography (MRA), magnetic resonance imaging (MRI), computed tomography (CT), ultrasonography, etc.), a navigation device, a global positioning system (GPS) receiver, an event data recorder (EDR), a flight data recorder (FDR), a car infotainment device, electronic equipment for ship (e.g., a marine navigation system, a gyrocompass, etc.), avionics, security equipment, or an industrial or home robot.

According to various embodiments of the present disclosure, an electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof. As well understood by those skilled in the art, the above-mentioned electronic devices are not to be considered as a limitation of this disclosure.

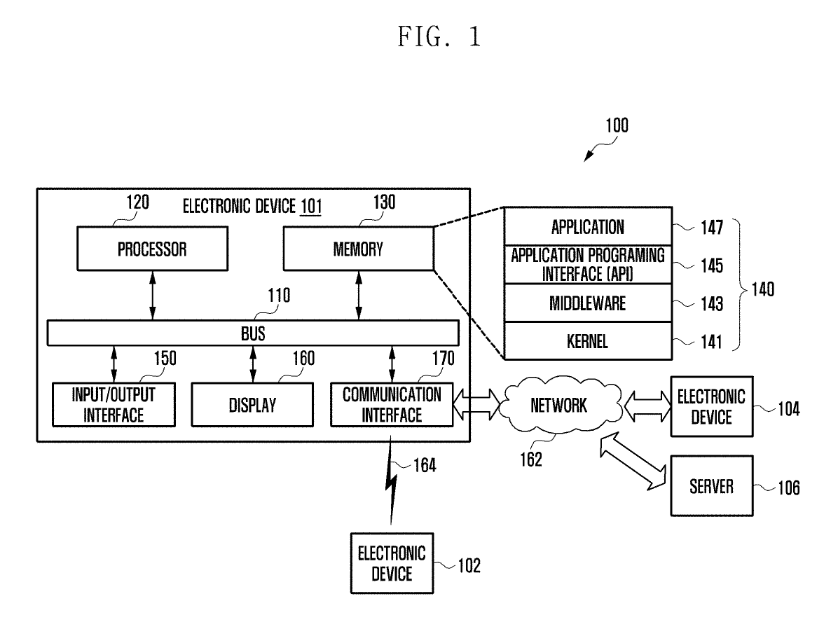

FIG. 1 is a block diagram 100 illustrating an electronic apparatus according to an embodiment of the present disclosure.

Referring to FIG. 1, the electronic apparatus 101 may include a bus 110, a processor 120, a memory 130, a user input module 150, a display 160, and a communication interface 170.

The bus 110 may be a circuit for interconnecting elements described above and for allowing a communication, e.g. by transferring a control message, between the elements described above.

The processor 120 can receive commands from the above-mentioned other elements, e.g. the memory 130, the user input module 150, the display 160, and the communication interface 170, through (for example) the bus 110, decipher the received commands, and perform operations and/or data processing according to the deciphered commands.

The memory 130 can store commands received from the processor 120 and/or other elements, e.g. the user input module 150, the display 160, and the communication interface 170, and/or commands and/or data generated by the processor 120 and/or other elements. The memory 130 may include software and/or programs 140, such as a kernel 141, middleware 143, an application programming interface (API) 145, and an application 147. Each of the programming modules described above may be configured by software, firmware, hardware, and/or combinations of two or more thereof.

The kernel 141 can control and/or manage system resources, e.g. the bus 110, the processor 120 or the memory 130, used for execution of operations and/or functions implemented in other programming modules, such as the middleware 143, the API 145, and/or the application 147. Further, the kernel 141 can provide an interface through which the middleware 143, the API 145, and/or the application 147 can access and then control and/or manage an individual element of the electronic apparatus 101.

The middleware 143 can perform a relay function which allows the API 145 and/or the application 147 to communicate with and exchange data with the kernel 141. Further, in relation to operation requests received from at least one of an application 147, the middleware 143 can perform load balancing in relation to the operation requests by, for example, giving a priority in using a system resource, e.g. the bus 110, the processor 120, and/or the memory 130, of the electronic apparatus 101 to at least one application from among the at least one of the application 147.

The API 145 is an interface through which the application 147 can control a function provided by the kernel 141 and/or the middleware 143, and may include, for example, at least one interface or function for file control, window control, image processing, and/or character control.

The user input module 150 can receive, for example, a command and/or data from a user, and transfer the received command and/or data to the processor 120 and/or the memory 130 through the bus 110. The display 160 can display an image, a video, and/or data to a user.

The communication interface 170 can establish a communication between the electronic apparatus 101 and other electronic devices 102 and 104 and/or a server 106. The communication interface 170 can support short range communication protocols, e.g. a Wi-Fi protocol, a Bluetooth (BT) protocol, and a near field communication (NFC) protocol, communication networks, e.g. internet, local area network (LAN), wide area network (WAN), a telecommunication network, a cellular network, and a satellite network, or a plain old telephone service (POTS), or any other similar and/or suitable communication networks, such as network 162, or the like. Each of the electronic devices 102 and 104 may be a same type and/or different types of electronic apparatus.

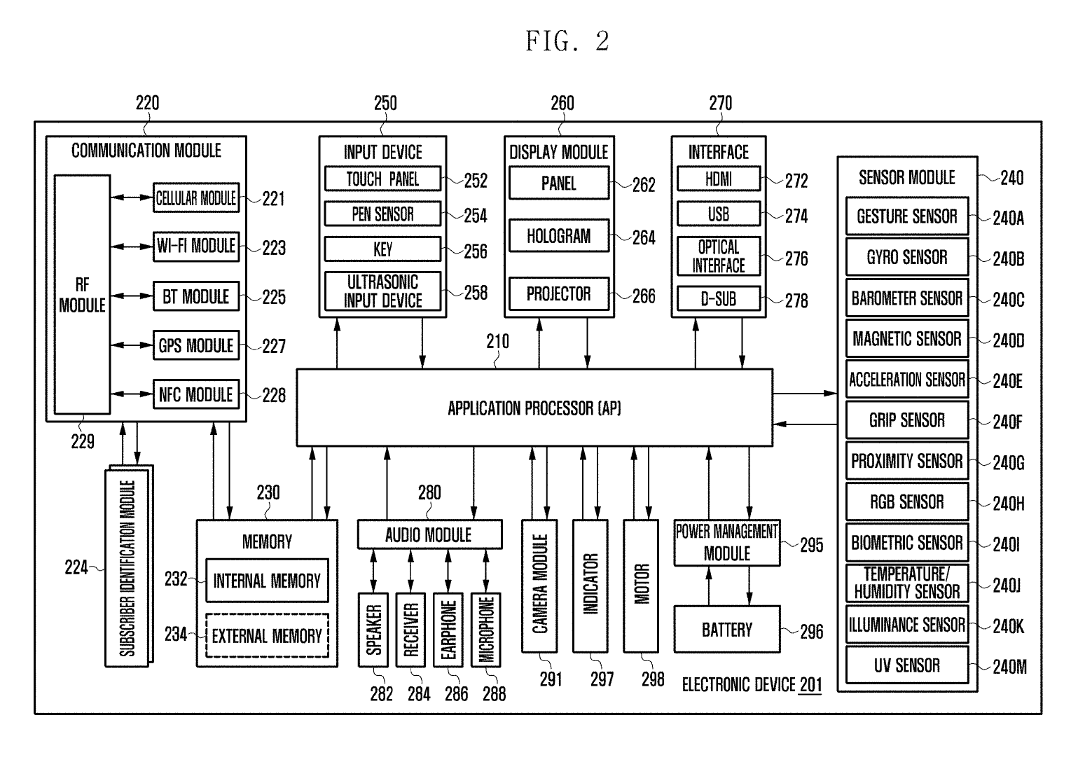

FIG. 2 is a block diagram illustrating an electronic device 201 according to an embodiment of the present disclosure. The electronic device 201 may form, for example, the whole or part of the electronic device 101 shown in FIG. 1.

Referring to FIG. 2, the electronic device 201 may include at least one application processor (AP) 210, a communication module 220, a subscriber identification module (SIM) card 224, a memory 230, a sensor module 240, an input unit 250, a display 260, an interface 270, an audio module 280, a camera module 291, a power management module 295, a battery 296, an indicator 297, and a motor 298.

The AP 210 may drive an operating system (OS) or applications, control a plurality of hardware or software components connected thereto, and also perform processing and operation for various data including multimedia data. The AP 210 may be formed of system-on-chip (SoC), for example. According to an embodiment, the AP 210 may further include a graphics processing unit (GPU) (not shown).

The communication module 220 (e.g., the communication interface 260) may perform a data communication with any other electronic device (e.g., the electronic device 104 or a server 106 shown in FIG. 1) connected to the electronic device 201 (e.g., the electronic device 101 shown in FIG. 1) through the network. According to an embodiment, the communication module 220 may include therein a cellular module 221, a Wi-Fi module 223, a BT module 225, a GPS module 227, an NFC module 228, and a radio frequency (RF) module 229.

The cellular module 221 may offer a voice call, a video call, a message service, an internet service, or the like through a communication network (e.g., long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM), etc.). Additionally, the cellular module 221 may perform identification and authentication of the electronic device in the communication network, using the SIM card 224. According to an embodiment, the cellular module 221 may perform at least part of functions the AP 210 can provide. For example, the cellular module 221 may perform at least part of a multimedia control function.

According to an embodiment, the cellular module 221 may include a communication processor (CP). Additionally, the cellular module 221 may be formed of SoC, for example. Although some elements such as the cellular module 221 (e.g., the CP), the memory 230, or the power management module 295 are shown as separate elements being different from the AP 210 in FIG. 2, the AP 210 may be formed to have at least part (e.g., the cellular module 221) of the above elements in an embodiment.

According to an embodiment, the AP 210 or the cellular module 221 (e.g., the CP) may load commands or data, received from a nonvolatile memory connected thereto or from at least one of the other elements, into a volatile memory to process them. Additionally, the AP 210 or the cellular module 221 may store data, received from or created at one or more of the other elements, in the nonvolatile memory.

Each of the Wi-Fi module 223, the BT module 225, the GPS module 227 and the NFC module 228 may include a processor for processing data transmitted or received therethrough. Although FIG. 2 shows the cellular module 221, the Wi-Fi module 223, the BT module 225, the GPS module 227 and the NFC module 228 as different blocks, at least part of them may be contained in a single integrated circuit (IC) chip or a single IC package in an embodiment. For example, at least part (e.g., the CP corresponding to the cellular module 221 and a Wi-Fi processor corresponding to the Wi-Fi module 223) of respective processors corresponding to the cellular module 221, the Wi-Fi module 223, the BT module 225, the GPS module 227 and the NFC module 228 may be formed as a single SoC.

The RF module 229 may transmit and receive data, e.g., RF signals or any other electric signals. Although not shown, the RF module 229 may include a transceiver, a power amp module (PAM), a frequency filter, a low noise amplifier (LNA), or the like. Also, the RF module 229 may include any component, e.g., a wire or a conductor, for transmission of electromagnetic waves in a free air space. Although FIG. 2 shows that the cellular module 221, the Wi-Fi module 223, the BT module 225, the GPS module 227 and the NFC module 228 share the RF module 229, at least one of them may perform transmission and reception of RF signals through a separate RF module in an embodiment.

The SIM card 224 may be a specific card formed of SIM and may be inserted into a slot formed at a certain place of the electronic device 201. The SIM card 224 may contain therein an IC card identifier (ICCID) or an international mobile subscriber identity (IMSI).

The memory 230 (e.g., the memory 230) may include an internal memory 232 and an external memory 234. The internal memory 232 may include, for example, at least one of a volatile memory (e.g., dynamic random access memory (DRAM), static RAM (SRAM), synchronous DRAM (SDRAM), etc.) or a nonvolatile memory (e.g., one time programmable read only memory (OTPROM), programmable ROM (PROM), erasable and programmable ROM (EPROM), electrically erasable and programmable ROM (EEPROM), mask ROM, flash ROM, NAND flash memory, NOR flash memory, etc.).

According to an embodiment, the internal memory 232 may have the form of a solid state drive (SSD). The external memory 234 may include a flash drive, e.g., compact flash (CF), secure digital (SD), micro-SD, mini-SD, extreme digital (xD), memory stick, or the like. The external memory 234 may be functionally connected to the electronic device 201 through various interfaces. According to an embodiment, the electronic device 201 may further include a storage device or medium such as a hard drive.

The sensor module 240 may measure physical quantity or sense an operating status of the electronic device 201, and then convert measured or sensed information into electric signals. The sensor module 240 may include, for example, at least one of a gesture sensor 240A, a gyro sensor 240B, an atmospheric or barometer sensor 240C, a magnetic sensor 240D, an acceleration sensor 240E, a grip sensor 240F, a proximity sensor 240G, a color sensor 240H (e.g., red, green, blue (RGB) sensor), a biometric sensor 240I, a temperature-humidity sensor 240J, an illumination sensor 240K, and a ultraviolet (UV) sensor 240M. Additionally or alternatively, the sensor module 240 may include, e.g., an electronic nose (E-nose) sensor (not shown), an electromyography (EMG) sensor (not shown), an electroencephalogram (EEG) sensor (not shown), an electrocardiogram (ECG) sensor (not shown), an infrared (IR) sensor (not shown), an iris scan sensor (not shown), or a finger scan sensor (not shown). Also, the sensor module 240 may include a control circuit for controlling one or more sensors equipped therein.

The input device 250 may include a touch panel 252, a digital pen sensor 254, a key 256, or an ultrasonic input unit 258. The touch panel 252 may recognize a touch input in a manner of capacitive type, resistive type, infrared type, or ultrasonic type. Also, the touch panel 252 may further include a control circuit. In case of a capacitive type, a physical contact or proximity may be recognized. The touch panel 252 may further include a tactile layer. In this case, the touch panel 252 may offer a tactile feedback to a user.

The digital pen sensor 254 may be formed in the same or similar manner as receiving a touch input or by using a separate recognition sheet. The key 256 may include, for example, a physical button, an optical key, or a keypad. The ultrasonic input unit 258 is a specific device capable of identifying data by sensing sound waves with a microphone 288 in the electronic device 201 through an input tool that generates ultrasonic signals, thus allowing wireless recognition. According to an embodiment, the electronic device 201 may receive a user input from any external device (e.g., a computer or a server) connected thereto through the communication module 220.

The display 260 (e.g., the display 160 shown in FIG. 1) may include a panel 262, a hologram 264, or a projector 266. The panel 262 may be, for example, liquid crystal display (LCD), active matrix organic light emitting diode), plastic OLED (POLED), or the like. The panel 262 may have a flexible, transparent or wearable form. The panel 262 may be formed of a single module with the touch panel 252. The hologram 264 may show a stereoscopic image in the air using interference of light. The projector 266 may project an image onto a screen, which may be located at the inside or outside of the electronic device 201. According to an embodiment, the display 260 may further include a control circuit for controlling the panel 262, the hologram 264, and the projector 266.

The interface 270 may include, for example, a high-definition multimedia interface (HDMI) 272, a universal serial bus (USB) 274, an optical interface 276, or a D-subminiature (D-sub) 278. The interface 270 may be contained, for example, in the communication interface 260 shown in FIG. 2. Additionally or alternatively, the interface 270 may include, for example, a mobile high-definition link (MHL) interface, an SD card/multi-media card (MMC) interface, or an infrared data association (IrDA) interface.

The audio module 280 may perform a conversion between sounds and electric signals. The audio module 280 may process sound information inputted or outputted through a speaker 282, a receiver 284, an earphone 286, or the microphone 288.

The camera module 291 is a device capable of obtaining still images and moving images. According to an embodiment, the camera module 291 may include at least one image sensor (e.g., a front sensor or a rear sensor), a lens (not shown), an image signal processor (ISP, not shown), or a flash (e.g., LED or xenon lamp, not shown).

The power management module 295 may manage electric power of the electronic device 201. Although not shown, the power management module 295 may include, for example, a power management IC (PMIC), a charger IC, or a battery or fuel gauge.

The PMIC may be formed, for example, of an IC chip or SoC. Charging may be performed in a wired or wireless manner. The charger IC may charge the battery 296 and prevent overvoltage or overcurrent from a charger. According to an embodiment, the charger IC may have a charger IC used for at least one of wired and wireless charging types. A wireless charging type may include, for example, a magnetic resonance type, a magnetic induction type, or an electromagnetic type. Any additional circuit for a wireless charging may be further used such as a coil loop, a resonance circuit, or a rectifier.

The battery gauge may measure the residual amount of the battery 296 and a voltage, current or temperature in a charging process. The battery 296 may store or create electric power therein and supply electric power to the electronic device 201. The battery 296 may be, for example, a rechargeable battery or a solar battery.

The indicator 297 may show thereon a current status (e.g., a booting status, a message status, or a recharging status) of the electronic device 201 or of its part (e.g., the AP 210). The motor 298 may convert an electric signal into a mechanical vibration. Although not shown, the electronic device 201 may include a specific processor (e.g., GPU) for supporting a mobile TV. This processor may process media data that comply with standards of digital multimedia broadcasting (DMB), digital video broadcasting (DVB), or media flow.

Each of the above-discussed elements of the electronic device disclosed herein may be formed of one or more components, and its name may be varied according to the type of the electronic device. The electronic device disclosed herein may be formed of at least one of the above-discussed elements without some elements or with additional other elements. Some of the elements may be integrated into a single entity that still performs the same functions as those of such elements before integrated.

The term “module” used in this disclosure may refer to a certain unit that includes one of hardware, software and firmware or any combination thereof. The module may be interchangeably used with unit, logic, logical block, component, or circuit, for example. The module may be the minimum unit, or part thereof, which performs one or more particular functions. The module may be formed mechanically or electronically. For example, the module disclosed herein may include at least one of application-specific IC (ASIC) chip, field-programmable gate arrays (FPGAs), and programmable-logic device, which have been known or are to be developed.

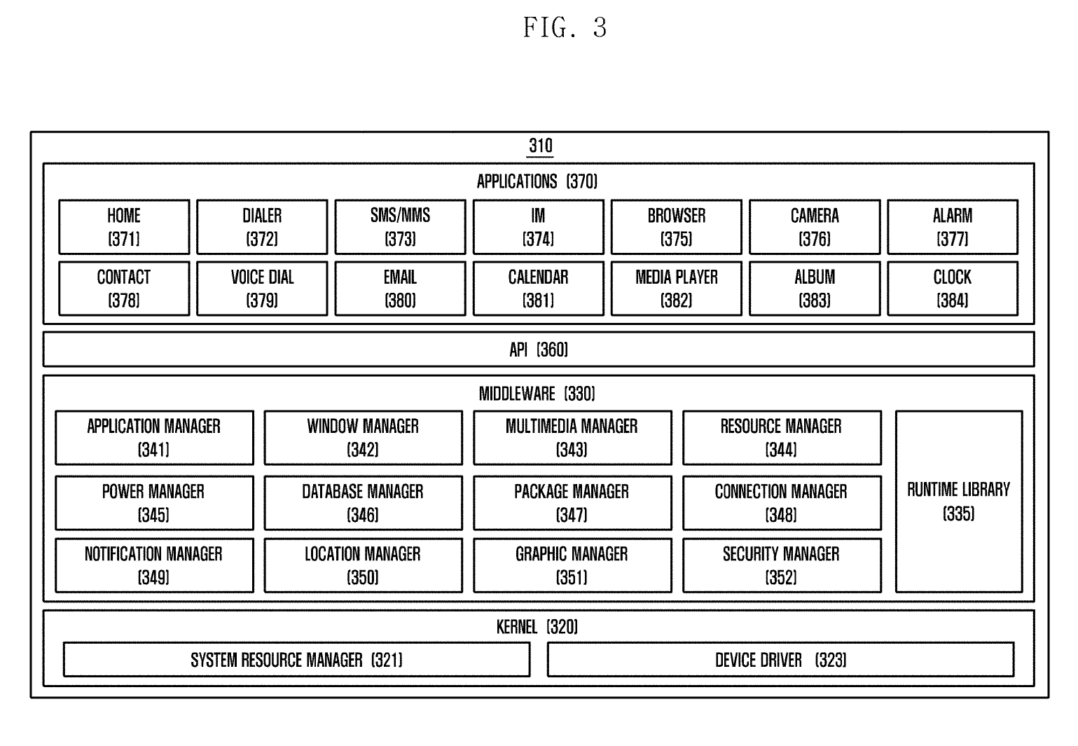

FIG. 3 is a block diagram illustrating a configuration of a programming module 310 according to an embodiment of the present disclosure.

The programming module 310 may be included (or stored) in the electronic device 201 (e.g., the memory 230) illustrated in FIG. 2 or may be included (or stored) in the electronic device 201 (e.g., the memory 230). At least a part of the programming module 310 may be implemented in software, firmware, hardware, or a combination of two or more thereof. The programming module 310 may be implemented in hardware, and may include an OS controlling resources related to an electronic device (e.g., the electronic device 101 or 201) and/or various applications (e.g., an application from applications 370) executed in the OS. For example, the OS may be Android™, iOS™, Windows™, Symbian®, Tizen®, Bada®, or the like.

Referring to FIG. 3, the programming module 310 may include a kernel 320, a middleware 330, an API 360, and/or one or more of the applications 370.

The kernel 320 (e.g., the kernel 141 shown in FIG. 1) may include a system resource manager 321 and/or a device driver 323. The system resource manager 321 may include, for example, a process manager (not illustrated), a memory manager (not illustrated), and a file system manager (not illustrated). The system resource manager 321 may perform the control, allocation, recovery, and/or the like of system resources. The device driver 323 may include, for example, a display driver (not illustrated), a camera driver (not illustrated), a BT driver (not illustrated), a shared memory driver (not illustrated), a USB driver (not illustrated), a keypad driver (not illustrated), a Wi-Fi driver (not illustrated), and/or an audio driver (not illustrated). Also, according to an embodiment of the present disclosure, the device driver 323 may include an inter-process communication (IPC) driver (not illustrated).

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device. For example, as illustrated in FIG. 3, the middleware 330 (e.g., the middleware 143 shown in FIG. 1) may include at least one of a runtime library 335, an application manager 341, a window manager 342, a multimedia manager 343, a resource manager 344, a power manager 345, a database manager 346, a package manager 347, a connectivity or connection manager 348, a notification manager 349, a location manager 350, a graphic manager 351, a security manager 352, and any other suitable and/or similar manager.

The runtime library 335 may include, for example, a library module used by a complier, in order to add a new function by using a programming language during the execution of the application 370. According to an embodiment of the present disclosure, the runtime library 335 may perform functions which are related to input and output, the management of a memory, an arithmetic function, and/or the like.

The application manager 341 may manage, for example, a life cycle of at least one of the applications 370. The window manager 342 may manage graphical user interface (GUI) resources used on the screen. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370.

The power manager 345 may operate together with a basic input/output system (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity or connection manager 348 may manage a wireless connectivity such as, for example, Wi-Fi and BT. The notification manager 349 may display or report, to the user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. According to an embodiment of the present disclosure, when the electronic device (e.g., the electronic device 201) has a telephone function, the middleware 330 may further include a telephony manager (not illustrated) for managing a voice telephony call function and/or a video telephony call function of the electronic device.

The middleware 330 may generate and use a new middleware module through various functional combinations of the above-described internal element modules. The middleware 330 may provide modules specialized according to types of OSs in order to provide differentiated functions. Also, the middleware 330 may dynamically delete some of the existing elements, or may add new elements. Accordingly, the middleware 330 may omit some of the elements described in the various embodiments of the present disclosure, may further include other elements, or may replace the some of the elements with elements, each of which performs a similar function and has a different name.

The API 360 (e.g., the API 145 shown in FIG. 1) is a set of API programming functions, and may be provided with a different configuration according to an OS. In the case of Android™ or iOS™, for example, one API set may be provided to each platform. In the case of Tizen®, for example, two or more API sets may be provided to each platform.

The applications 370 (e.g., the applications 147 shown in FIG. 1) may include, for example, a preloaded application and/or a third-party application. The applications 370 (e.g., the applications 147) may include, for example, a home application 371, a dialer application 372, a short message service (SMS)/multimedia message service (MMS) application 373, an instant message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application.

At least a part of the programming module 310 may be implemented by instructions stored in a non-transitory computer-readable storage medium. When the instructions are executed by one or more processors (e.g., the AP 210 shown in FIG. 2), the one or more processors may perform functions corresponding to the instructions. The non-transitory computer-readable storage medium may be, for example, the memory 230. At least a part of the programming module 310 may be implemented (e.g., executed) by, for example, the one or more processors. At least a part of the programming module 310 may include, for example, a module, a program, a routine, a set of instructions, and/or a process for performing one or more functions.

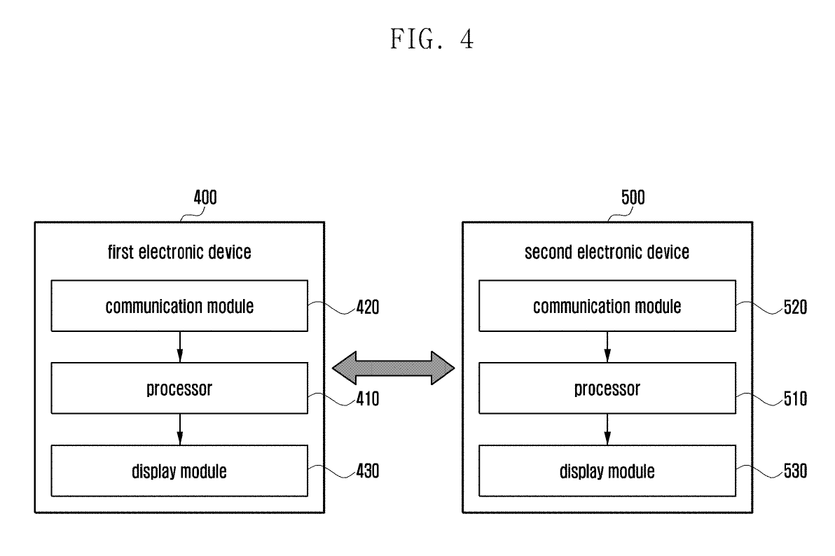

FIG. 4 is a block diagram of electronic devices according to various embodiments of the present disclosure.

In various embodiments of the present disclosure, a first electronic device 400 and a second electronic device 500 may send and receive data through a network connection. The first electronic device 400 and the second electronic device 500 may each correspond to the electronic device 101, the electronic device 102, the electronic device 104, or the electronic device 201 (shown in FIG. 1 or FIG. 2).

The first electronic device 400 may include a processor 410, a communication module 420, and a display module 430. The second electronic device 500 may include a processor 510, a communication module 520, and a display module 530. The first electronic device 400 and the second electronic device 500 may each further include one or more components of the electronic device 101 shown in FIG. 1 or the electronic device 201 shown in FIG. 2. The processor 410 and the processor 510 may each correspond to the processor 120 shown in FIG. 1 or the application processor 210 shown in FIG. 2. The communication module 420 and the communication module 520 may each correspond to the communication interface 170 shown in FIG. 1 or the communication module 220 shown in FIG. 2. The display module 430 and the display module 530 may each correspond to the display 160 shown in FIG. 1 or the display 260 shown in FIG. 2.

In one embodiment of the present disclosure, the second electronic device 500 may receive an application display request from an external device. The second electronic device 500 may receive an application display request from the first electronic device 400. Here, the application display request may be related to the content or data of an application running on the first electronic device 400 (i.e. the content or data currently being displayed by the first electronic device 400).

In one embodiment of the present disclosure, the first electronic device 400 may discover devices connectable through wireless communication (e.g. wireless short-range communication like Wi-Fi direct). Wi-Fi direct refers to a communication scheme enabling devices to easily connect with each other without requiring separate equipment like an access point (AP) or router.

When the second electronic device 500 is discovered as a device to be connected, the first electronic device 400 and the second electronic device 500 may exchange connection setup data with each other. For example, the first electronic device 400 and the second electronic device 500 may exchange information regarding supported codecs, codec profiles, codec levels, and resolutions with each other. Data exchange may be performed by using messages based on a real-time streaming protocol (RTSP). For example, data transmission between the first electronic device 400 and the second electronic device 500 may be performed through application mirroring (e.g. full minoring or app minoring).

Here, in full mirroring, data stored in the frame buffer of the first electronic device 400 may be sent to another electronic device (e.g. second electronic device 500). Audio and video data may be sent to the second electronic device 500 through the real-time transport protocol (RTP) and virtual network computing (VNC) protocol, and touch events occurring in the second electronic device 500 may be sent back to the first electronic device 400 for control. In app mirroring, a specific application on the first electronic device 400 may sent data to the second electronic device 500, and the second electronic device 500 may receive the data and output video and audio data. That is, the application running on the first electronic device 400 may send and receive data to and from the corresponding application running on the second electronic device 500 through a pre-agreed protocol.

Upon reception of a signal, the processor 510 of the second electronic device 500 may determine a region of the screen to display application data. Upon reception of the request signal from the first electronic device 400, the second electronic device 500 may determine a region of the screen to be used to display a mirrored screen image sent by the first electronic device 400.

The processor 510 may display application data related to the external device (e.g. first electronic device 400) (mirrored screen image) in the determined region of the screen. Here, the processor 510 may display a mirrored screen image sent by the first electronic device 400 in the determined region of the screen as it is, or after scaling up or down the mirrored screen image.

The region of the screen for a mirrored screen image may be determined on the basis of information received from the external device (e.g. first electronic device 400). For example, the second electronic device 500 may receive information on the region of the screen being used to display application data from the first electronic device 400. The second electronic device 500 may identify and determine the region of the screen to display mirrored application data on the basis of the information received from the first electronic device 400.

The region of the screen to display a mirrored screen image may be identified or determined on the basis of information pre-stored in the second electronic device 500. The region to display a mirrored screen image may be changed on the screen according to update input from the first electronic device 400 or the second electronic device 500.

In one embodiment of the present disclosure, the processor 510 of the second electronic device 500 may display at least one application window in the remaining region of the screen excluding the region assigned for displaying a mirrored screen image. That is, the second electronic device 500 may display at least one application window in the remaining region of the screen excluding the region assigned to a window for displaying application data received from an application running on the first electronic device 400.

When an external device (e.g. first electronic device 400) is connected with the second electronic device 500, the processor 510 may identify the remaining region of the screen excluding the region assigned to the window displaying a mirrored screen image associated with an application running on the external device on the basis of screen information of the external device pre-stored in the memory (not shown). Screen information (e.g. resolution and color) of multiple external devices may be pre-stored in the memory of the second electronic device 500.

Display capability information (e.g. manufacturer and model number) of multiple external devices may be pre-stored in the memory of the second electronic device 500. For example, when an external device (e.g. first electronic device 400) is connected, the processor 510 may extract screen information (e.g. screen size) of the first electronic device 400 from the display capability information stored in the memory. On the basis of the extracted screen information, the processor 510 may identify the region of the screen assigned to a window for displaying a mirrored screen image associated with an application running on the first electronic device 400 and identify the remaining region of the screen by excluding the region assigned to the window for displaying a mirrored screen image.

In one embodiment of the present disclosure, when an external device (e.g. first electronic device 400) is connected, the processor 510 may identify a region of the screen whose screen property does not change for a given time or more as the remaining region. For example, after a mirrored screen image associated with the first electronic device 400 is displayed in a region of the screen of the second electronic device 500, the processor 510 may identify a region of the screen whose screen property (e.g. black color) does not change for a given time (e.g. 0.05, 0.1, or 0.2 second) as the remaining region.

The processor 510 of the second electronic device 500 may receive an input signal from at least one of a connected external input unit (e.g. remote control) and the connected external device (e.g. first electronic device 400) for changing the mirrored screen image displayed in the designated region of the screen or at least one application window displayed in the remaining region. For example, the processor 510 may receive an input signal for changing the arrangement of the mirrored screen image on the screen or replacing one application window on the screen with another application window.

Upon reception of a change input signal, the processor 510 may change the arrangement of at least one of the mirrored screen image and the application window on the screen. The processor 510 may change the arrangement of the mirrored screen image associated with the first electronic device 400 or an application window on the screen.

In one embodiment of the present disclosure, the processor 510 may display at least one application window in the remaining region of the screen on the basis of at least one of network status information, application activation information, and operating system (OS) information of the second electronic device 500.

In one embodiment of the present disclosure, the processor 510 may determine an application whose content is to be displayed in the remaining region of the screen on the basis of presence or activation of the OS in the second electronic device 500. The processor 510 may check presence of an application whose content is displayed on the screen. For example, when an application is activated in the second electronic device 500, the processor 510 may control the activated application so that a window corresponding to the activated application is displayed in the remaining region of the screen. As another example, when no application is activated in the second electronic device 500, the processor 510 may control an application not related to the second electronic device 500 so that a window corresponding to the unrelated application is displayed in the remaining region of the screen.

For instance, when the second electronic device 500 is a TV, the processor 510 may determine an application whose content is to be displayed in the remaining region of the screen on the basis of whether the screen is being used for program display. As another instance, the processor 510 may determine an application whose content is to be displayed in the remaining region of the screen on the basis of whether the second electronic device 500 supports supplementary content services (e.g. smart hub). As another instance, the processor 510 may determine an application whose content is to be displayed in the remaining region of the screen on the basis of whether the second electronic device 500 supports an in-vehicle infotainment system.

In one embodiment of the present disclosure, the processor 510 may display at least one application window in the remaining region of the screen in response to a user input signal for application display. For example, in response to selection of an option among screen options of the second electronic device 500, the processor 510 may determine the type of an application whose content is to be displayed in the remaining region of the screen.

In one embodiment of the present disclosure, the processor 510 may display application content unrelated with the second electronic device 500 or the first electronic device 400 in the remaining region of the screen. For example, the processor 510 may display an advertisement or news content provided by the manufacturer or another agent in the remaining region of the screen.

In one embodiment of the present disclosure, the processor 510 may display application content related only to the second electronic device 500 in the remaining region of the screen. The processor 510 may display information associated with a currently activated application. For example, when a music application is currently activated, the processor 510 may display music-related content such as songwriter information, music video, music chart ranking or music news in the remaining region of the screen.

In one embodiment of the present disclosure, the processor 510 may display application content related only to an external device (e.g. first electronic device 400) in the remaining region of the screen. For example, the processor 510 may receive status information and application activation information (e.g. icons, widgets, and foreground and background applications on the standby screen of the first electronic device 400) from the first electronic device 400. The processor 510 may also receive status information of multiple external devices interworking with the first electronic device 400 from the first electronic device 400.

In one embodiment of the present disclosure, the processor 510 may display application content related to the first electronic device 400 in the remaining region of the screen on the basis of the received information. For example, the processor 510 may receive application content played back by the first electronic device 400 from the first electronic device 400. The processor 510 may also receive metadata about applications from the first electronic device 400. Metadata of content is information regarding the created location, description, author, usage rights of the content, and may be in the form of an html tag.

In one embodiment of the present disclosure, upon reception of a display request for application content associated with an application placed in the background of the first electronic device 400, the processor 510 may activate the corresponding application on the basis of a signal from the background of the second electronic device 500, and display the output of the activated application in the remaining region of the screen.

In one embodiment of the present disclosure, the processor 510 may display application content related to both the second electronic device 500 and an external device (e.g. first electronic device 400) in the remaining region of the screen. For example, the processor 510 may display application content associated with the second electronic device 500 in a portion of the remaining region of the screen and display application content associated with the first electronic device 400 in another portion thereof.

In one embodiment of the present disclosure, the processor 510 may display information related to application content displayed in one region of the screen in the remaining region. Specifically, when application content containing text data is displayed in one region of the screen, the processor 510 may extract text data from the application content, send a query request based on the extracted text data to an external server, and display information received as a response from the external server in the remaining region of the screen. For example, when shopping content is displayed in one region of the screen, the processor 510 may extract article information from the shopping content, send a request for price and sales information of the article to an external server, and display price and sales information received as a response from the external server in the remaining region of the screen.

In one embodiment of the present disclosure, while application content associated with an application running on the first electronic device 400 is being displayed in one region of the screen, the processor 510 may receive a screen layout change signal from the first electronic device 400. For example, when the display mode is changed from a first mode (e.g. landscape mode) to a second mode (e.g. portrait mode) in the first electronic device 400 executing the above application, the first electronic device 400 may send a display mode change signal to the second electronic device 500. Upon reception of the display mode change signal, the processor 510 may display application content associated with the application running on the first electronic device 400 in the region of the screen and display information related to the application in the remaining region of the screen.

For example, when the application is a photograph viewer, the processor 510 may display a photograph in one region of the screen and display metadata (e.g. captured location or map) of the photograph in the remaining region of the screen. When the application is a movie player, the processor 510 may display a movie scene in one region of the screen and display supplementary data of the movie (e.g. rating, characters, related images, movie channel list, and installed movie applications) in the remaining region of the screen. When the application is a music player, the processor 510 may display an image related to the currently played music in the remaining region of the screen. When the application is a music player and the second electronic device 500 is a TV, the processor 510 may display a list of music channels, names of speakers attached to the second electronic device 500, and a volume control application in the remaining region of the screen. When the application is a game program, the processor 510 may display an image related to the game and a list of games stored in the second electronic device 500 in the remaining region of the screen.

In one embodiment of the present disclosure, the processor 510 may receive an input event for selecting an application whose content is displayed in the remaining region of the screen and send a display request corresponding to the selection input event to one external device (e.g. first electronic device 400). Then, the first electronic device 400 may add or change the selected application in the standby screen, the background screen, or the current screen.

In one embodiment of the present disclosure, the processor 510 may receive an input for selecting an application whose content is displayed in the remaining region of the screen and display the output of the selected application in the full screen format. Upon reception of a new input, the processor 510 may recover the previous display format by displaying application content in one region of the screen and in the remaining region thereof.

In one embodiment of the present disclosure, when the application whose content is displayed on the first electronic device 400 is changed, the processor 510 may change the application content displayed in one region of the screen and the application information displayed in the remaining region of the screen. For example, a music application for a first singer may be executed and then replaced with a music application for a second singer in the first electronic device 400. Before application switching, the second electronic device 500 may display a mirrored screen image for the first singer in one region of the screen and display information related to the song of the first singer (e.g. channel information and sound source information) in the remaining region of the screen. After application switching, the processor 510 may display a mirrored screen image for the second singer in the region of the screen and display information related to the song of the second singer (e.g. chart ranking, rating, and source site) in the remaining region of the screen.

In one embodiment of the present disclosure, when there are multiple application windows to be displayed according to a request signal, the processor 510 may determine the screen layout on the basis of information regarding the window arrangement, screen size and application states in an external device (e.g. first electronic device 400), and display the multiple application windows according to the determined screen layout.

When there are multiple application windows to be displayed, the processor 510 may arrange the application windows on the screen according to a preset order. For example, when application windows are stacked on top of each other in the first electronic device 400, the corresponding application windows may be arranged next to each other on the screen of the second electronic device 500 so that the leftmost window corresponds to the topmost window in the first electronic device 400. The processor 510 may arrange application windows on the screen of the second electronic device 500 in descending order of size of the corresponding application windows in the first electronic device 400. The processor 510 may arrange application windows on the screen of the second electronic device 500 in chronological order of creation of the corresponding application windows in the first electronic device 400.

In various embodiments of the present disclosure, the first electronic device 400 may include a processor 410, a communication module 420, and a display module 430.

In one embodiment of the present disclosure, the processor 410 may receive an input signal for selecting a region of the screen of an external device (e.g. second electronic device 500) used to display an application window associated with the first electronic device 400. The memory (not shown) of the first electronic device 400 may store screen capability information (e.g. screen size, resolution) of external devices interworking with the first electronic device 400. The first electronic device 400 may be connected with the second electronic device 500 through wireless communication (e.g. wireless LAN like Wi-Fi direct). For example, the first electronic device 400 may discover the second electronic device 500 for communication, perform capability exchange and negotiation with the second electronic device 500 according to Wi-Fi direct, and send and receive data to and from the second electronic device 500 through the real time streaming protocol (RTSP).

In one embodiment of the present disclosure, on the basis of data exchanged with the second electronic device 500, the processor 410 may display an image item that enables a region of the screen of the second electronic device 500 to be selected for displaying an application window associated with the first electronic device 400. Upon detection of user input on the image item on the screen, the processor 410 may determine the screen layout for the application indicated by the user input.

In one embodiment of the present disclosure, the processor 410 may determine the arrangement of application windows in the remaining region of the screen of the second electronic device 500. The arrangement of application windows may be determined automatically according to procedures stored in the first electronic device 400 or manually according to user input.

In one embodiment of the present disclosure, the processor 410 may determine the arrangement of application windows on the basis of at least one of application execution states and display status information of the first electronic device 400. For example, when an application is running in the background of the first electronic device 400, the processor 410 may determine the arrangement so that an application window associated with the first electronic device 400 is displayed in the remaining region of the screen of the second electronic device 500. As another example, when the current screen of the first electronic device 400 is the standby screen and no application is running in the background, the processor 410 may determine the arrangement so that an application window not associated with the first electronic device 400 is displayed in the remaining region of the screen of the second electronic device 500.

In one embodiment of the present disclosure, for an application window to be displayed in the remaining region of the screen, the processor 410 may receive an input for selecting an application whose content is not associated with the first electronic device 400 or the external device (e.g. second electronic device 500). Application content not associated therewith may be information or news provided by manufacturers or communication operators, and may be definable and changeable by the user.

In one embodiment of the present disclosure, for an application window to be displayed in the remaining region of the screen, the processor 410 may receive an input for selecting an application whose content is associated only with the first electronic device 400. The processor 410 may determine an application window to be displayed in the remaining region of the screen of the second electronic device 500 on the basis of states of applications running in the background. The processor 410 may determine an application window to be displayed in the remaining region of the screen of the second electronic device 500 on the basis of icons and widgets on the standby screen of the first electronic device 400 and states of external devices connected with the first electronic device 400 (e.g. speaker and external server).

In one embodiment of the present disclosure, the processor 410 may determine the arrangement of application windows according to user input for selection. For an application window to be displayed in the remaining region of the screen, the processor 410 may receive an input for selecting an application whose content is associated only with an external device (e.g. second electronic device 500). For the remaining region of the screen, the processor 410 may receive an input for selecting an application whose content is associated with both the first electronic device 400 and an external device (e.g. second electronic device 500).

In one embodiment of the present disclosure, on the basis of the received selection input and determined application arrangement, the processor 410 may send an application display request to the external device (e.g. second electronic device 500). For example, upon reception of an input for an application whose content is associated with the first electronic device 400, the processor 410 may perform the corresponding action in the background. The processor 410 may activate a corresponding application placed in the background and send the output of the application to the second electronic device 500.

In one embodiment of the present disclosure, the processor 410 may receive an input for controlling the arrangement of application windows displayed on one external device (e.g. second electronic device 500). Upon reception of the input, the processor 410 may send an application arrangement adjustment request to the external device (e.g. second electronic device 500). For example, the first electronic device 400 may receive an input for changing the position of an application window or replacing one application window with another on the second electronic device 500. According to the received input, the first electronic device 400 may send an application arrangement adjustment request to the second electronic device 500.

In one embodiment of the present disclosure, from an external device (e.g. second electronic device 500) having detected an input event on an application window displayed in the remaining region of the screen, the processor 410 may receive a request signal for displaying an application window corresponding to the input event on the screen of the first electronic device 400.

The processor 410 may display an application window corresponding to the input event on the screen of the first electronic device 400. For example, in response to a request for changing the application window displayed in the remaining region of the screen of the second electronic device 500 to a full screen window, the processor 410 may add a corresponding application to the standby screen of the first electronic device 400.

In one embodiment of the present disclosure, the processor 410 may receive information regarding currently displayed application windows from an external device (e.g. second electronic device 500), and compose a background screen of the first electronic device 400 on the basis of the received information.

In one embodiment of the present disclosure, the processor 410 may receive an input for changing an application belonging to the background screen of the first electronic device 400, and send an application change request to the external device (e.g. second electronic device 500) on the basis of the received input.

In various embodiments of the present disclosure, the second electronic device 500 may include a processor 510, a communication module 520, and a display module 530. In one embodiment, the processor 510 may receive, from an external device (e.g. first electronic device 400), an application display request for displaying an application window associated with the external device, determine one region of the screen to be used for displaying the application window associated with the external device, and display at least one application window in the remaining region of the screen except for the determined region.

In one embodiment of the present disclosure, when an external device (e.g. first electronic device 400) is connected with the second electronic device 500, the processor 510 of the second electronic device 500 may identify the remaining region of the screen by excluding the region assigned to a window displaying a mirrored screen image associated with an application running on the external device on the basis of screen information of the external device pre-stored in the memory, or may identify a region of the screen whose screen property does not change for a given time or more as the remaining region.

In one embodiment of the present disclosure, the processor 510 of the second electronic device 500 may receive an input signal from at least one of a connected external input unit (e.g. remote control) and the connected external device (e.g. first electronic device 400) for changing the mirrored screen image displayed in the designated region of the screen or at least one application window displayed in the remaining region, and change the arrangement of at least one of the mirrored screen image and the application window on the screen according to the received input signal.

In one embodiment of the present disclosure, the processor 510 of the second electronic device 500 may display at least one application window in the remaining region of the screen on the basis of at least one of network status information, application activation information, and OS information of the second electronic device 500 or as a response to user input for application display.

In one embodiment of the present disclosure, the processor 510 of the second electronic device 500 may display application content in the remaining region of the screen. Here, the application content may be unrelated with the second electronic device 500 or the external device (e.g. first electronic device 400), be related only to the second electronic device 500, be related only to the external device (e.g. first electronic device 400), or be related to both the second electronic device 500 and the external device (e.g. first electronic device 400).

In one embodiment of the present disclosure, the processor 510 of the second electronic device 500 may use the remaining region of the screen to display information associated with the application content displayed in the designated region of the screen.

In one embodiment of the present disclosure, the processor 510 of the second electronic device 500 may receive an input event for selecting an application whose content is displayed in the remaining region of the screen and send a display request corresponding to the selection input event to the external device (e.g. first electronic device 400).

In one embodiment of the present disclosure, when there are multiple application windows to be displayed according to the request signal, the processor 510 of the second electronic device 500 may determine the screen layout on the basis of information regarding the window arrangement, screen size and application states in the external device (e.g. first electronic device 400), and display the multiple application windows according to the determined screen layout.

In various embodiments of the present disclosure, the first electronic device 400 may include a processor 410, a communication module 420, and a display module 430. In one embodiment, the processor 410 of the first electronic device 400 may receive an input signal for selecting a region of the screen of an external device (e.g. second electronic device 500) used to display an application window associated with the first electronic device 400, determine the arrangement of application windows in the remaining region of the screen of the second electronic device 500, and send an application display request to the external device (e.g. second electronic device 500).

In one embodiment of the present disclosure, for an application window to be displayed in the remaining region of the screen of the external device, the processor 410 of the first electronic device 400 may receive an input signal for selecting an application whose content is not associated with the first electronic device 400 or the external device (e.g. second electronic device 500), selecting an application whose content is associated only with the first electronic device 400, selecting an application whose content is associated only with the external device, or selecting an application whose content is associated with both the first electronic device 400 and the external device.

In one embodiment of the present disclosure, the processor 410 may determine the arrangement of application windows on the basis of at least one of application execution states and background screen status information of the first electronic device 400.

In one embodiment of the present disclosure, the processor 410 may receive an input signal for controlling the arrangement of application windows displayed on the external device (e.g. second electronic device 500), and send an application arrangement adjustment request to the external device as a response to the input signal.

In one embodiment of the present disclosure, from the external device (e.g. second electronic device 500) having detected an input event on an application window displayed in the remaining region of the screen, the processor 410 may receive a request signal for displaying an application window corresponding to the input event on the screen of the first electronic device 400.

In one embodiment of the present disclosure, the processor 410 may receive information regarding currently displayed application windows from the external device (e.g. second electronic device 500), and compose a background screen of the first electronic device 400 on the basis of the received information.

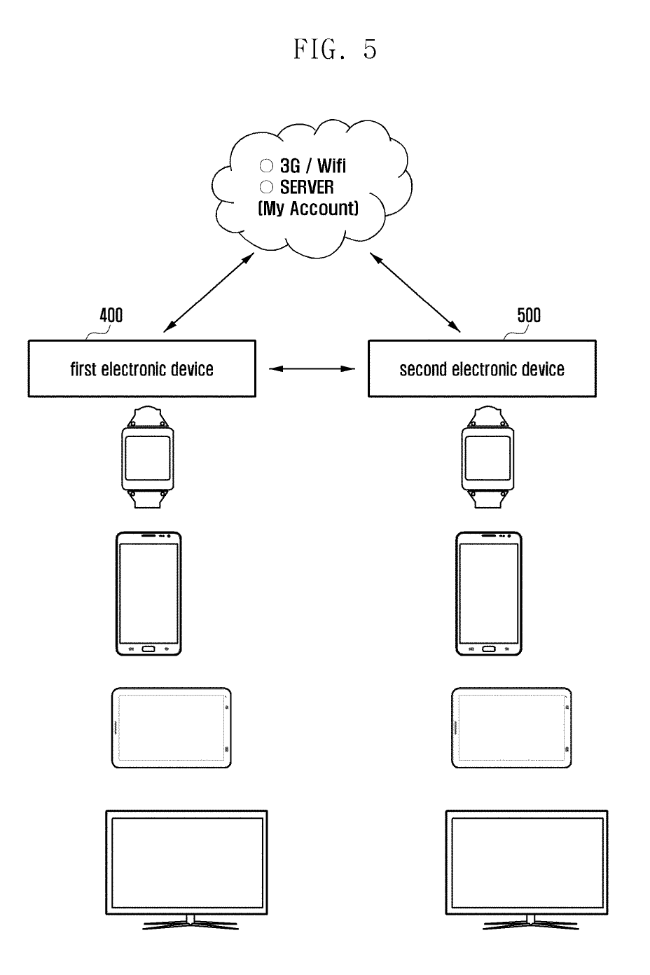

FIG. 5 illustrates examples of the electronic devices 400 and 500 according to various embodiments of the present disclosure.

In various embodiments of the present disclosure, the first electronic device 400 and the second electronic device 500 may send and receive data through wireless communication (e.g. third generation (3G), LTE, Wi-Fi, or Wi-Fi direct). The first electronic device 400 and the second electronic device 500 may share an account through an external server. For example, the user of the first electronic device 400 may create an account at the external server using an ID and password, and the second electronic device 500 may use and share content stored in the external server through the account.

In one embodiment of the present disclosure, the first electronic device 400 and the second electronic device 500 may each be a smartphone, tablet computer, mobile phone, video phone, e-book reader, desktop computer, laptop computer, netbook computer, workstation, server, personal digital assistant (PDA), portable multimedia player (PMP), MP3 player, medical instrument, camera, or wearable device. The wearable device may be of an accessory type (e.g. watch, ring, bracelet, ankle bracelet, necklace, eyeglasses, contact lens, head-mounted device (HMD)), a fabric or clothing integrated type (e.g. electronic clothing), a body-mounted type (e.g. skin pad, tattoo), a bio-implantable type (e.g. implantable circuit), or the like. The first electronic device 400 and the second electronic device 500 may each be a TV, DVD player, set-top box, home automation control panel, security control panel, media box (such as Samsung HomeSync™, Apple TV™ or Google TV™), electronic dictionary, electronic key, camcorder, or electronic frame.

In one embodiment of the present disclosure, the first electronic device 400 and the second electronic device 500 may each be a navigation aid, global navigation satellite system (GNSS), event data recorder (EDR), flight data recorder (FDR), vehicle infotainment device, marine electronic device (such as a marine navigation system or gyrocompass), avionics instrument, security equipment, vehicle head unit, automatic teller machine (ATM), or point of sales (POS) equipment.

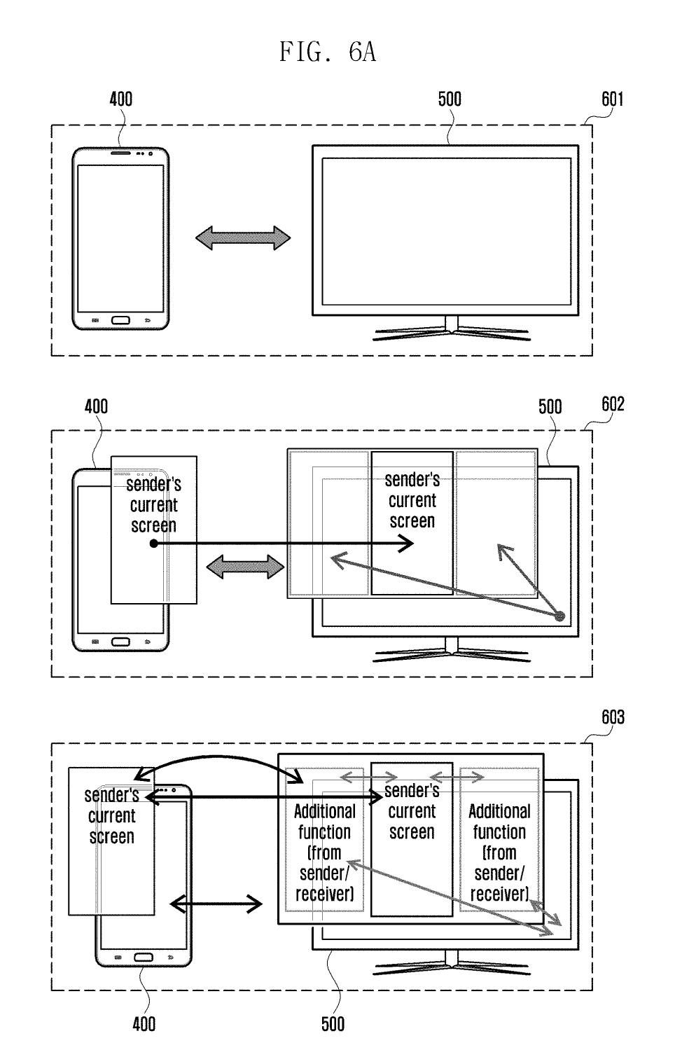

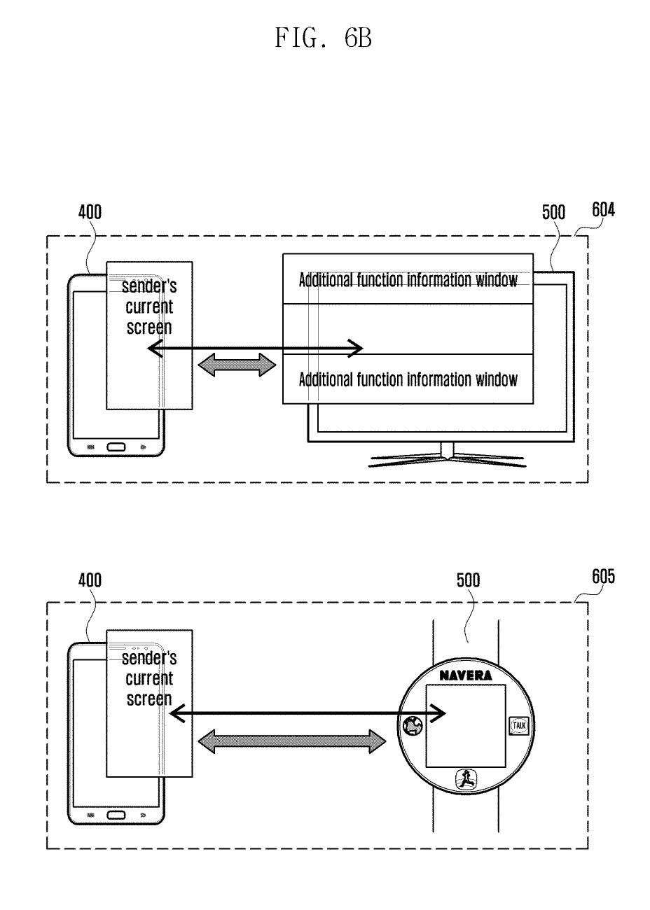

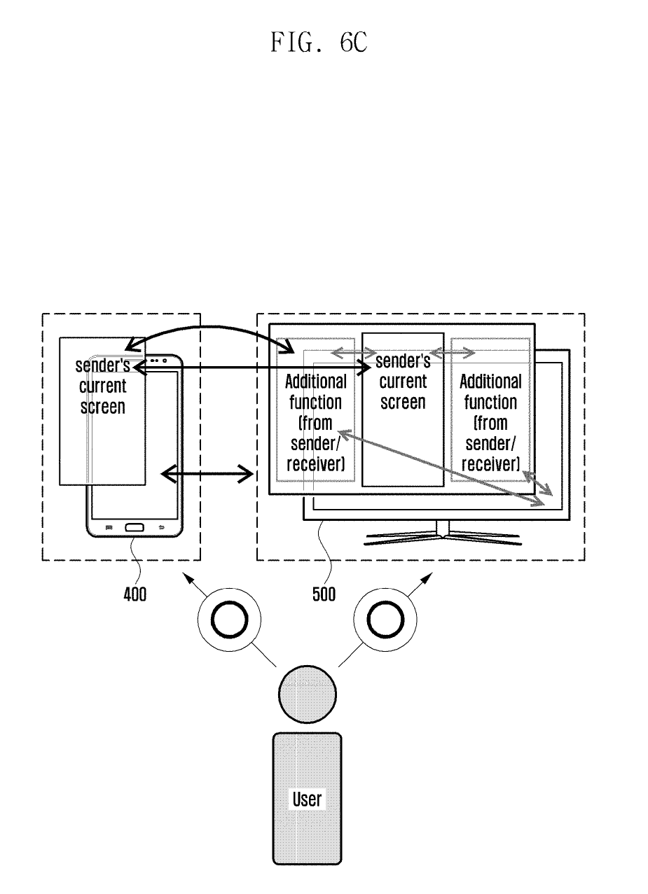

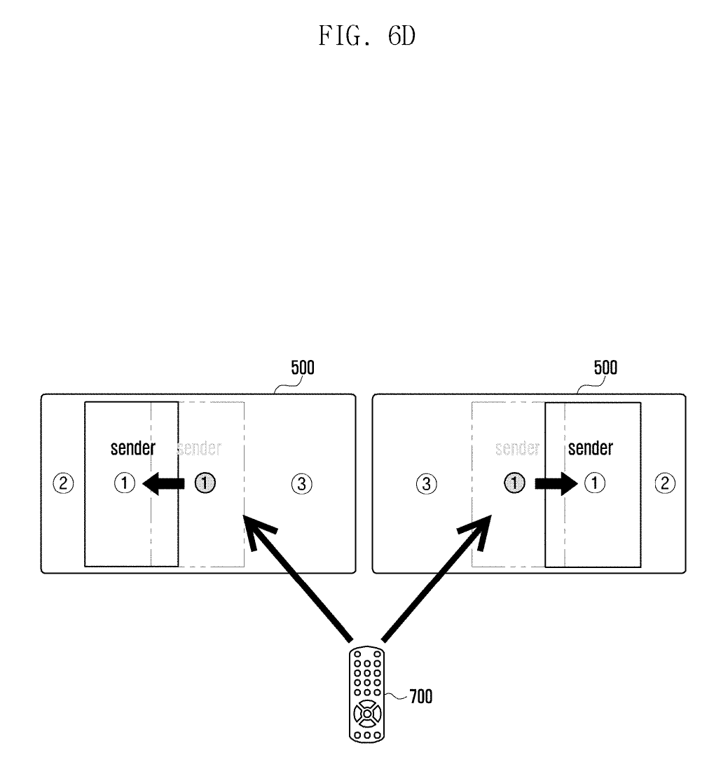

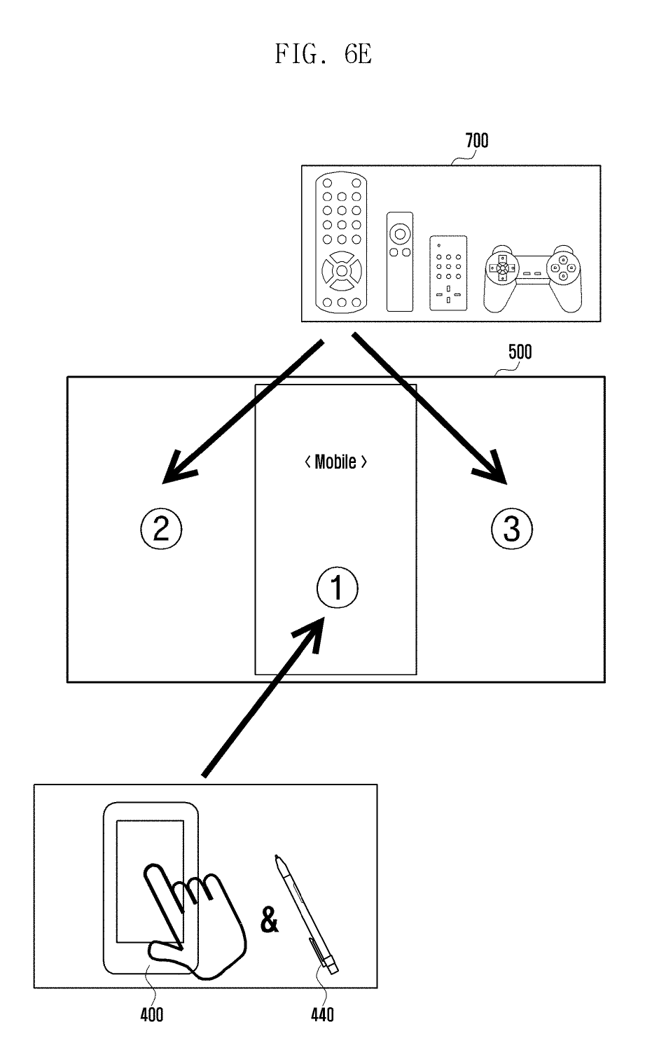

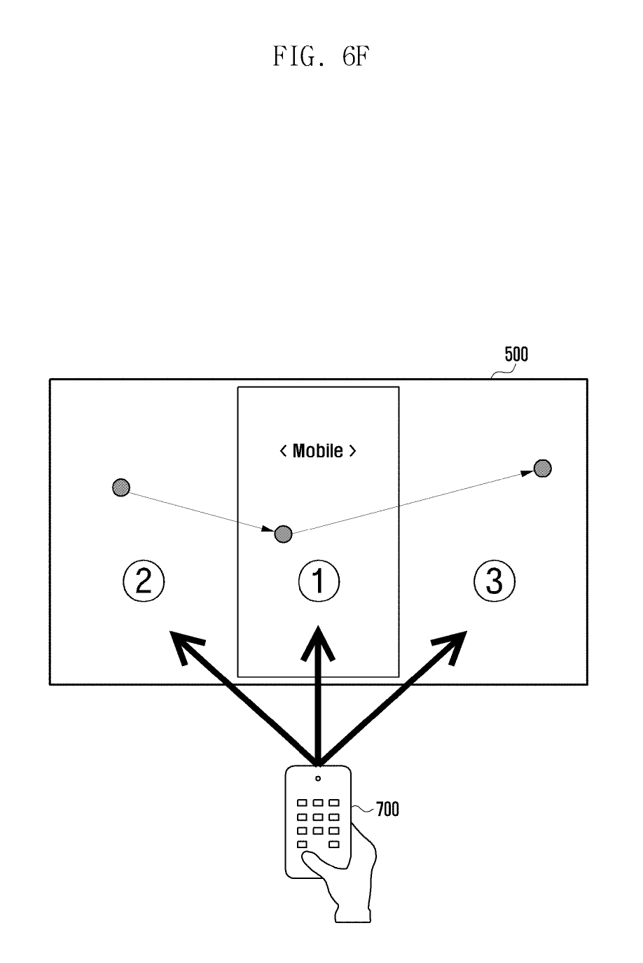

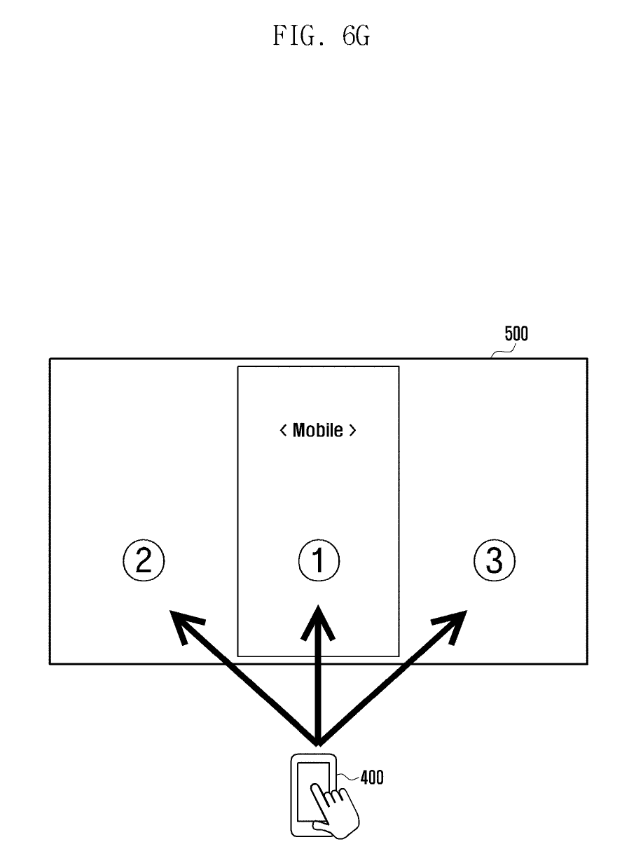

FIGS. 6A to 6G are illustrations of application display on electronic devices according to various embodiments of the present disclosure.

Referring to FIG. 6A, as indicated by indicia 601, the first electronic device 400 and the second electronic device 500 may send and receive data through wireless communication. The first electronic device 400 and the second electronic device 500 may be connected together through short-range wireless communication (e.g. Wi-Fi direct).

As indicated by indicia 602, the second electronic device 500 may display application content that is currently displayed on the first electronic device 400. For example, the second electronic device 500 may display application content that is currently displayed on the first electronic device 400 by use of Wi-Fi display or AirPlay Mirroring. Application content associated with the first electronic device 400 may be sent to the second electronic device 500 through the real time streaming protocol (RTSP). The second electronic device 500 may display an application window associated with the second electronic device 500 in the remaining region of the screen.

Referring to the situation indicated by indicia 603, the second electronic device 500 may display an application window, which presents a mirrored screen image received from the first electronic device 400, in a designated region of the screen. The second electronic device 500 may display a window for supplementary functions in the remaining region of the screen except for the designated region. Such a supplementary function window may be associated with the application window displayed in the designated region, associated with at least one of the first electronic device 400 and the second electronic device 500, or associated with general information.

Referring to FIG. 6B, as indicated by indicia 604, the second electronic device 500 may display an application window, which presents a mirrored screen image received from the first electronic device 400, in a designated region of the screen. The second electronic device 500 may display a window for supplementary functions in the remaining region of the screen. Here, in the second electronic device 500, the windows may be arranged horizontally on the screen.

Referring to the situation indicated by indicia 605, the second electronic device 500 is a wearable device and may display application content, which is currently displayed on the first electronic device 400, in a designated region of the screen. The second electronic device 500 may display supplementary information (e.g. icons or device related information) in the remaining region of the screen.

Referring to FIG. 6C, application windows displayed on the first electronic device 400 and the second electronic device 500 may be controlled by use of the first electronic device 400, the second electronic device 500, or an external input unit attached to the electronic device 400 or 500.

Referring to FIG. 6D, an external input unit 700 (e.g. remote control) interworking with the second electronic device 500 may be used to change the arrangement of windows displayed on the screen of the second electronic device 500. For example, the position of a particular application window may be changed (e.g. shifted to the left or right) by entering a specific key of the external input unit 700.

Referring to FIG. 6E, the arrangement of application windows displayed on the screen may be changed by use of the first electronic device 400, a first external input unit 440 (e.g. stylus pen or digital pen) interworking with the first electronic device 400, or a second external input unit 700 (e.g. remote control) interworking with the second electronic device 500.

Referring to FIGS. 6F and 6G, the arrangement of application windows displayed on the screen of the second electronic device 500 may be controlled by use of an external input unit 700 (e.g. remote control) interworking with the second electronic device 500 or the first electronic device 400 handling touch input. For example, when a function of the application window associated with the first electronic device 400 is selected by using the pointer of the external input unit 700 interworking with the second electronic device 500, the second electronic device 500 may send corresponding coordinate values to the first electronic device 400. Then, the first electronic device 400 may perform a requested operation on the basis of the received information.

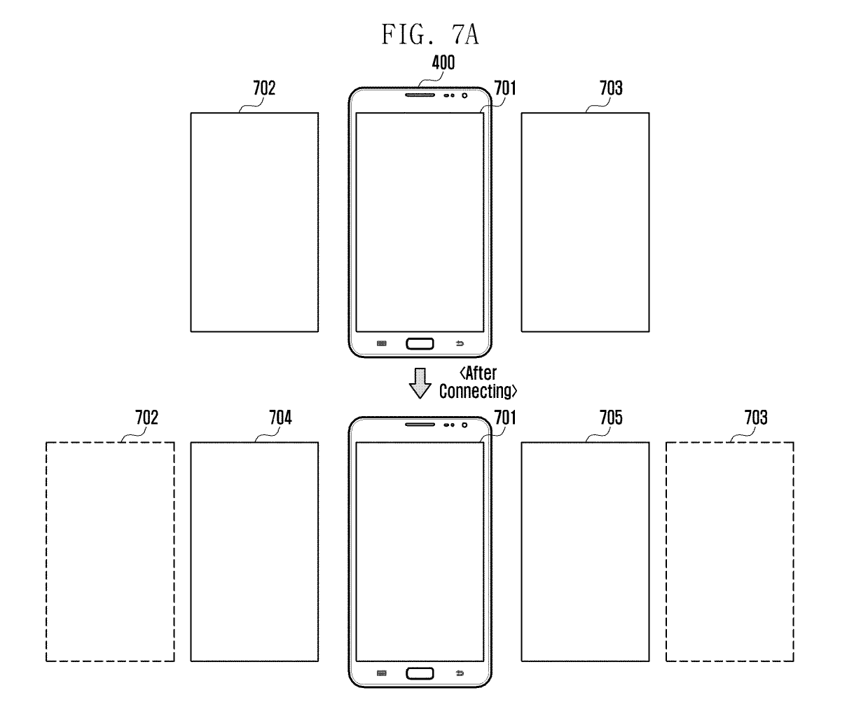

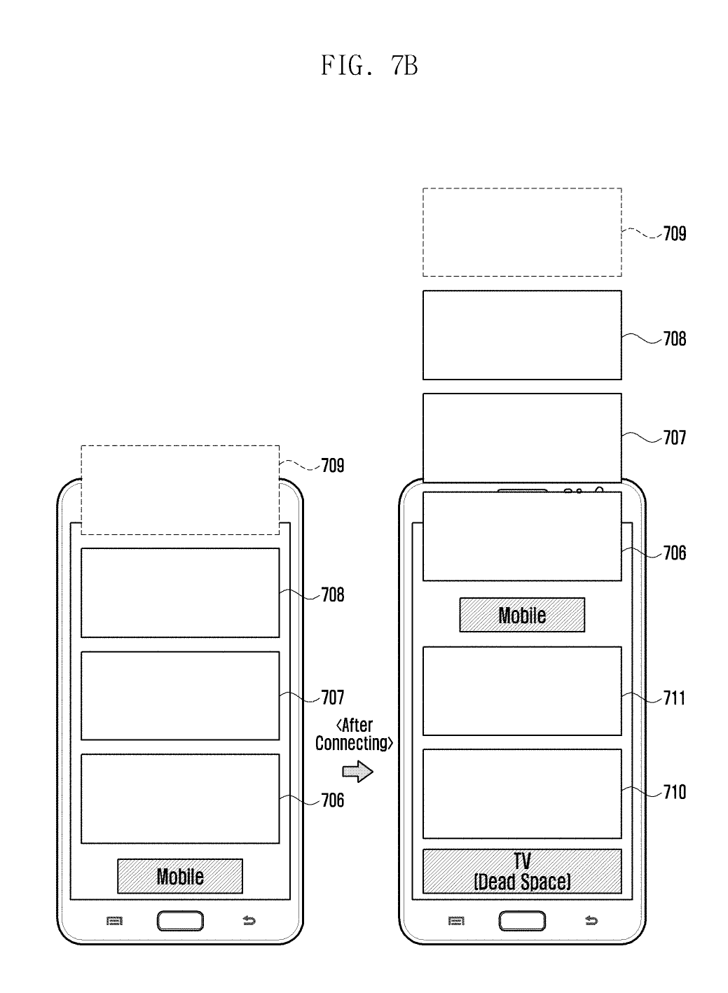

FIGS. 7A and 7B are illustrations of application display on an electronic device according to various embodiments of the present disclosure.

Referring to FIG. 7A, the first electronic device 400 may compose multiple standby windows 701, 702 and 703 before being connected with the second electronic device 500. In response to user input, the first electronic device 400 may display the first window 701 on the screen among the multiple standby windows 701, 702 and 703. Thereafter, when a touch and swipe input is detected while the first window 701 is being displayed, the first electronic device 400 may replace the first window 701 with the second window 702 or the third window 703.

When the second electronic device 500 is connected, the first electronic device 400 may receive information on applications whose content is displayed on the screen from the second electronic device 500. The second electronic device 500 may display an application window (e.g. first window 701), which presents a mirrored screen image received from the first electronic device 400, in a designated region of the screen. The second electronic device 500 may display a window for supplementary functions (e.g. information associated with the electronic device 400 or 500 or information associated with the application being displayed) in the remaining region of the screen. When a supplementary window is displayed in the remaining region of the screen, the second electronic device 500 may send information on the displayed windows to the first electronic device 400. Upon reception of the information from the second electronic device 500, the first electronic device 400 may change the home screen so that it includes windows 704 and 705 corresponding to the windows of the second electronic device 500 in addition to the standby windows 701, 702 and 703.

Upon detection of an input event on the added window 704 or 705, the first electronic device 400 may send a change request corresponding to the input event to the second electronic device 500. For example, upon detection of an input event on a uniform resource locator (URL) of the added window 704, the first electronic device 400 may access a website corresponding to the URL, and send state change information indicating the website access to the second electronic device 500. Upon reception of the state change information, the second electronic device 500 may change or update application windows or the arrangement thereof on the screen accordingly.

Referring to FIG. 7B, the first electronic device 400 may add windows corresponding to the windows 710 and 711 displayed on the second electronic device 500 to the existing standby windows 706, 707, 708 and 709. The first electronic device 400 may select or control an application belonging to a specific standby window.

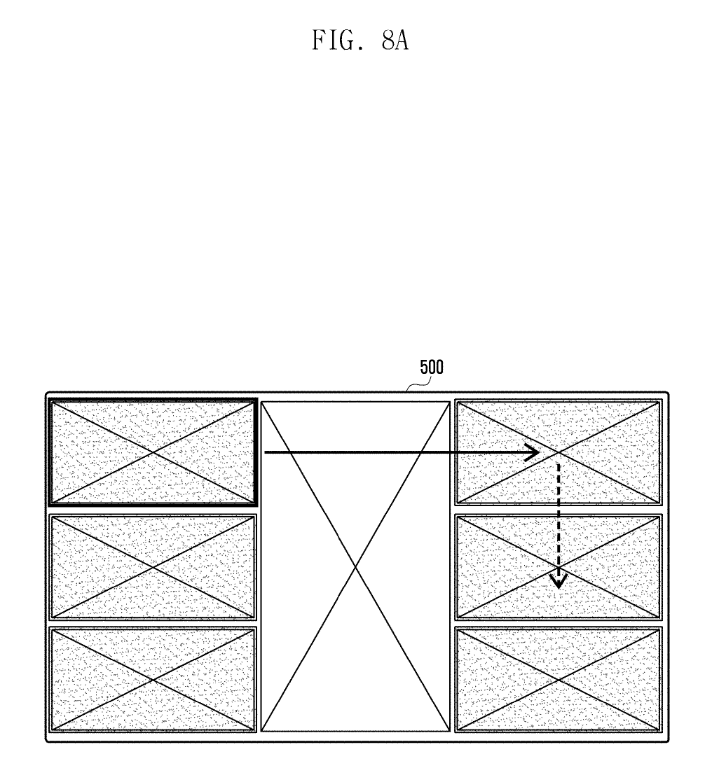

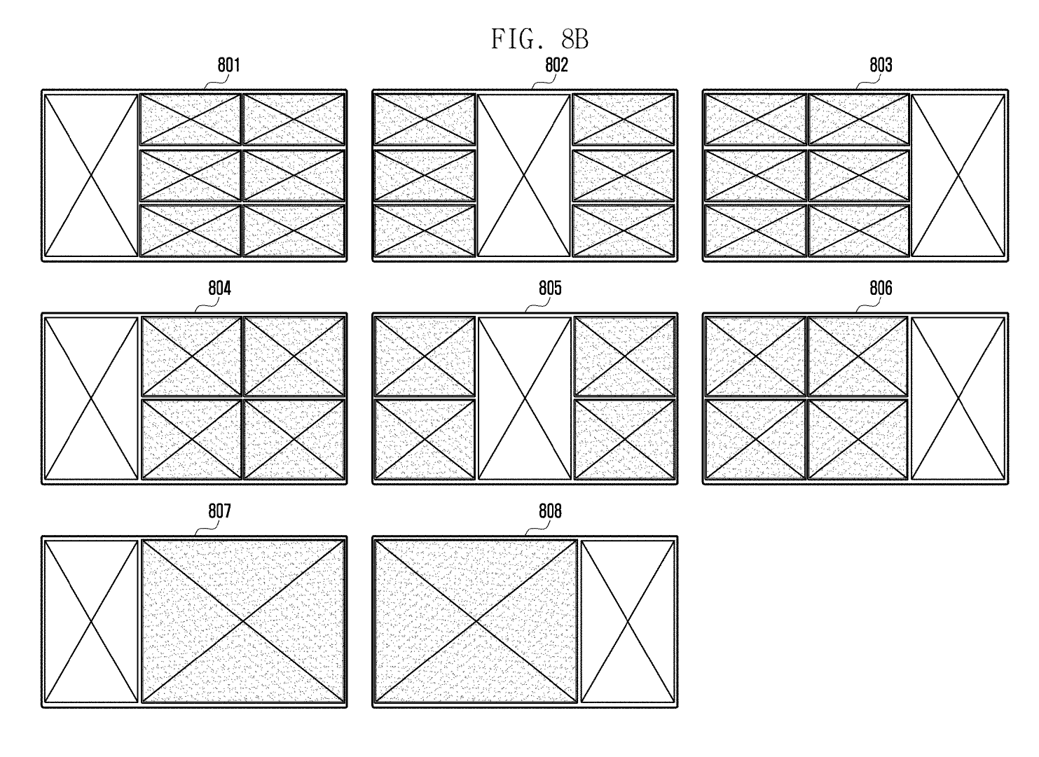

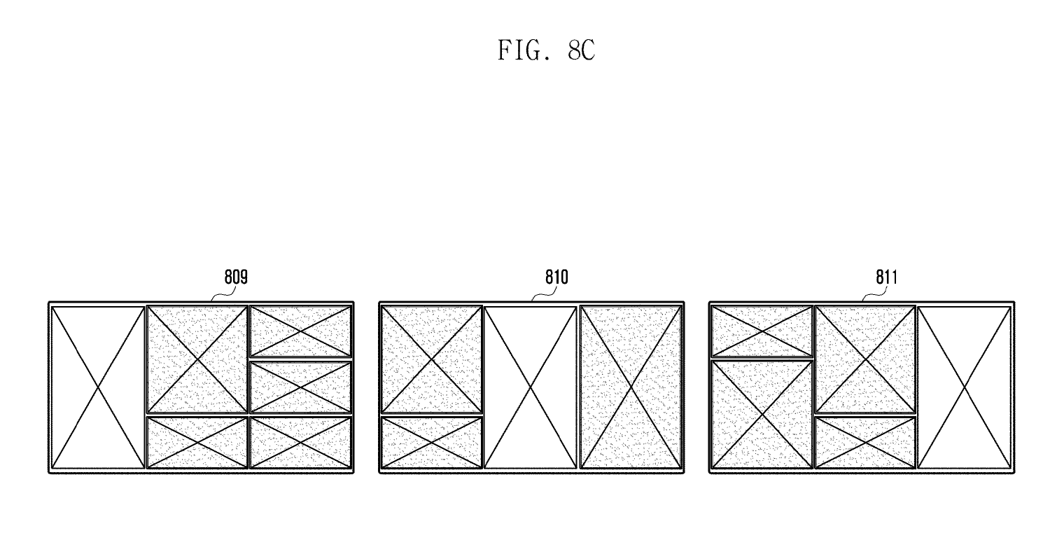

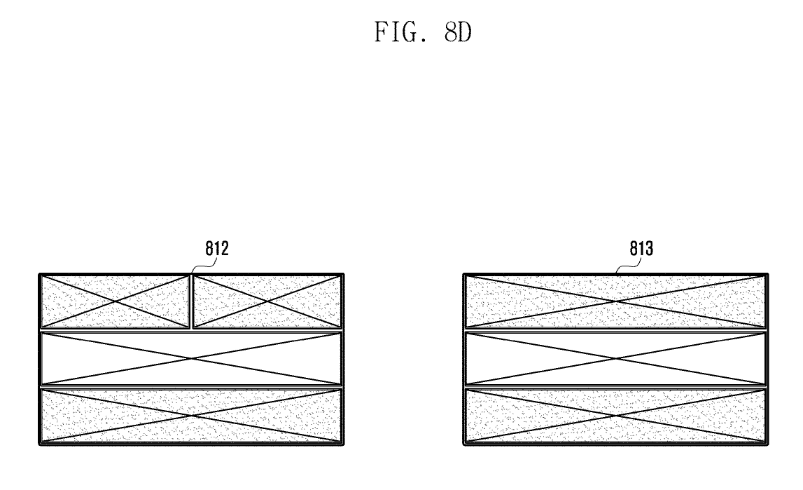

FIGS. 8A to 8D are illustrations of application display on an electronic device according to various embodiments of the present disclosure.

Referring to FIG. 8A, the second electronic device 500 may display multiple application windows on the screen thereof. The second electronic device 500 may display an application window, which presents a mirrored screen image received from the first electronic device 400, in a designated region of the screen. The second electronic device 500 may detect an input signal for moving one application window on the screen. Upon detection of an input signal for moving one application window, the second electronic device 500 may change the arrangement of the application window on the screen.

Referring to FIG. 8B, the second electronic device 500 may vary the arrangement of application windows displayed in the remaining region of the screen except for the region assigned to a window for presenting a mirrored screen image received from the first electronic device 400 and the region assigned for presenting supplementary information. The arrangement of application windows displayed on the screen of the second electronic device 500 may be changed or controlled by use of the first electronic device 400, the second electronic device 500, or an external input unit interworking with the first electronic device 400 or the second electronic device 500.

As indicated by indicia 801, 802 or 803, the screen of the second electronic device 500 may be divided into one region and the remaining region, and the region is assignable to a window and the remaining region may be split into six sections each assignable to one window.

As indicated by indicia 804, 805 or 806, the screen of the second electronic device 500 may be divided into one region and the remaining region, and the region is assignable to a window and the remaining region may be split into four sections each assignable to one window.

As indicated by indicia 807 or 808, the screen of the second electronic device 500 may be divided into one region and the remaining region, and the region is assignable to a window and the remaining region is assignable to a large window.

Referring to FIG. 8C, as indicated by indicia 809, 810 or 811, the screen of the second electronic device 500 may be divided into one region and the remaining region, and the region is assignable to a window and the remaining region may be split into three to five sections each assignable to one window.

Referring to FIG. 8D, as indicated by indicia 812 or 813, the screen of the second electronic device 500 may be divided horizontally into one region and the remaining region, and the region is assignable to a window in a landscape format and the remaining region may be split horizontally into two to three sections each assignable to one window in a landscape format.

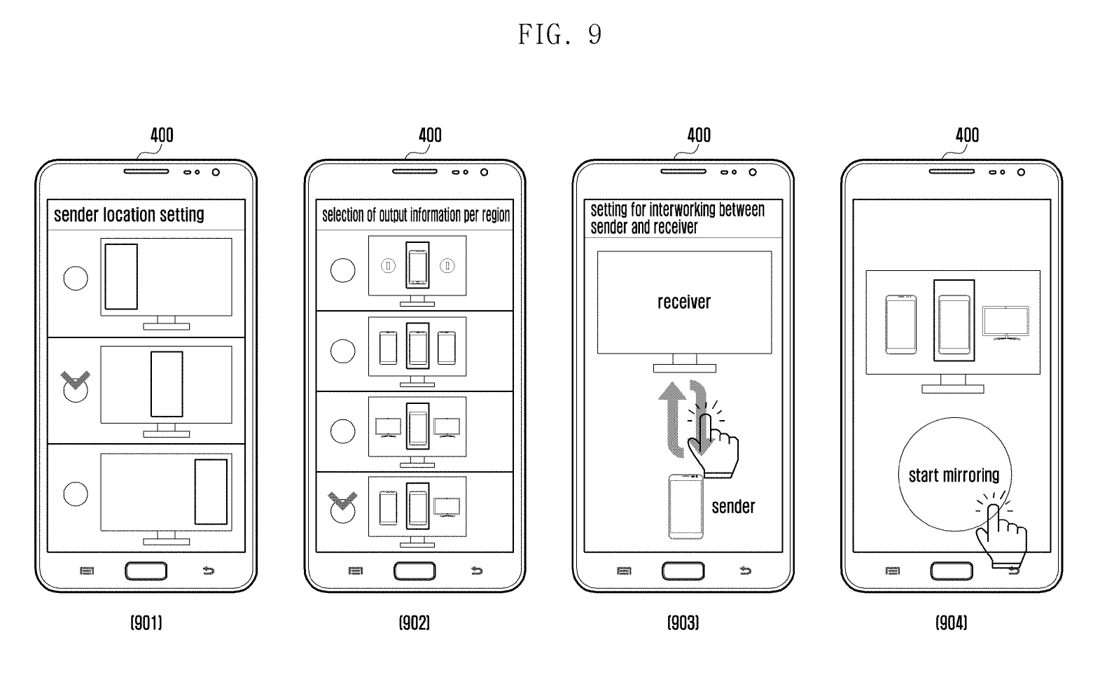

FIG. 9 illustrates application display on an electronic device according to various embodiments of the present disclosure.

In various embodiments of the present disclosure, the first electronic device 400 may determine the arrangement of application windows on the screen of the second electronic device 500.

As indicated by indicia 901, the first electronic device 400 may determine a region of the screen of the second electronic device 500 to be used for presenting a mirrored screen image from the first electronic device 400. The first electronic device 400 may identify the screen size of the second electronic device 500 on the basis of received or pre-stored display capability information of the second electronic device 500.

The first electronic device 400 may determine the scale-up ratio or scale-down ratio by comparing the display capability information of the first electronic device 400 with that of the second electronic device 500. The first electronic device 400 may display an image item that enables the region of the screen of the second electronic device 500 to be selected for presenting a mirrored screen image from the first electronic device 400.

The first electronic device 400 may detect an input signal for selecting one of the image items on the screen. On the basis of the selected image item, the first electronic device 400 may determine the region of the screen of the second electronic device 500 to be used for presenting a mirrored screen image from the first electronic device 400.

As indicated by indicia 902, the first electronic device 400 may select supplementary information to be displayed in the remaining region of the screen of the second electronic device 500.

In one embodiment of the present disclosure, the supplementary information may be not associated with the first electronic device 400 or the external device (e.g. second electronic device 500). For example, the supplementary information may be news or weather information. The first electronic device 400 may display an image item as a selection option enabling device independent information to be presented in the remaining region of the screen of the second electronic device 500.

In one embodiment of the present disclosure, the supplementary information may be associated with the first electronic device 400. For example, the supplementary information associated with the first electronic device 400 may be information regarding activated applications of the first electronic device 400, icons and widgets of the standby screen, and states of connections with other external devices. The first electronic device 400 may display an image item as a selection option enabling supplementary information associated with the first electronic device 400 to be presented in the remaining region of the screen of the second electronic device 500.

In one embodiment of the present disclosure, the supplementary information may be associated with the second electronic device 500. For example, the supplementary information associated with the second electronic device 500 may be information regarding activated applications of the second electronic device 500. The first electronic device 400 may display an image item as a selection option enabling supplementary information associated with the second electronic device 500 to be presented in the remaining region of the screen of the second electronic device 500.

In one embodiment of the present disclosure, the supplementary information may be associated with both the first electronic device 400 and the second electronic device 500. For example, when the screen of the second electronic device 500 is divided into multiple sections, some of the sections may be used to display application windows associated with the first electronic device 400 and the other sections may be used to display application windows associated with the second electronic device 500. The first electronic device 400 may display an image item as a selection option enabling supplementary information associated with both the first electronic device 400 and the second electronic device 500 to be presented in the remaining region of the screen of the second electronic device 500.

The first electronic device 400 may detect an input signal for selecting one of the image items (options) displayed on the screen. Upon detection of an input signal for selecting one image item, the first electronic device 400 may determine the arrangement of application windows in the remaining region of the screen of the second electronic device 500 on the basis of the selected image item.

As indicated by indicia 903, the first electronic device 400 may determine the scheme of interworking between the first electronic device 400 and the second electronic device 500. For example, the first electronic device 400 may be given the right to make an application change request to the second electronic device 500, and the second electronic device 500 may be given the right to change an application window associated with the first electronic device 400.

As indicated by indicia 904, the first electronic device 400 may initiate the screen mirroring function to send the screen image in real-time to the second electronic device 500. The first electronic device 400 and the second electronic device 500 may send and receive display-related data through screen mirroring.

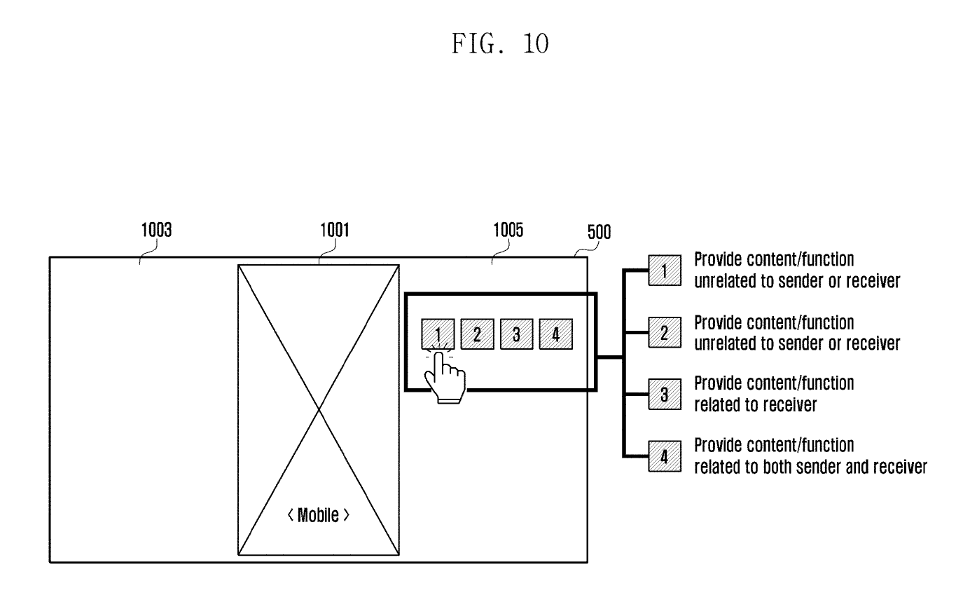

FIG. 10 illustrates application display on an electronic device according to various embodiments of the present disclosure.

Referring to FIG. 10, the second electronic device 500 may display an application window for a mirrored screen image received from the first electronic device 400 in one region 1001 of the screen and display a window for supplementary information in the remaining region 1003 or 1005.

The second electronic device 500 may determine the supplementary information to be displayed in the remaining region 1003 or 1005. For example, as a response to user input, the second electronic device 500 may display independent supplementary information not associated with the second electronic device 500 or the first electronic device 400 in the remaining region 1003 or 1005. As a response to user input, the second electronic device 500 may display supplementary information associated only with the second electronic device 500 in the remaining region 1003 or 1005. As a response to user input, the second electronic device 500 may display supplementary information associated only with the first electronic device 400 in the remaining region 1003 or 1005. As a response to user input, the second electronic device 500 may display supplementary information associated with both the second electronic device 500 and the first electronic device 400 in the remaining region 1003 or 1005.

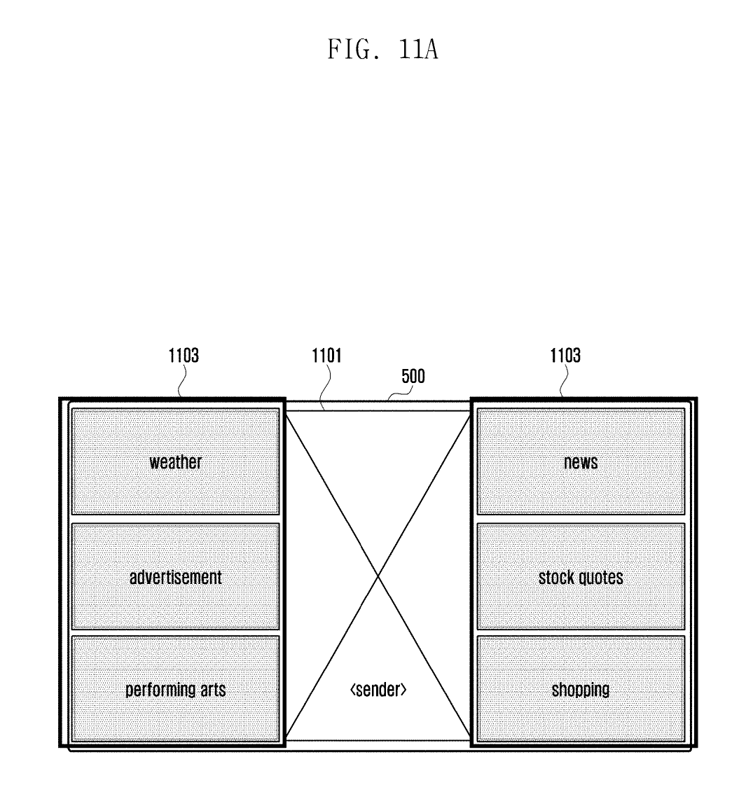

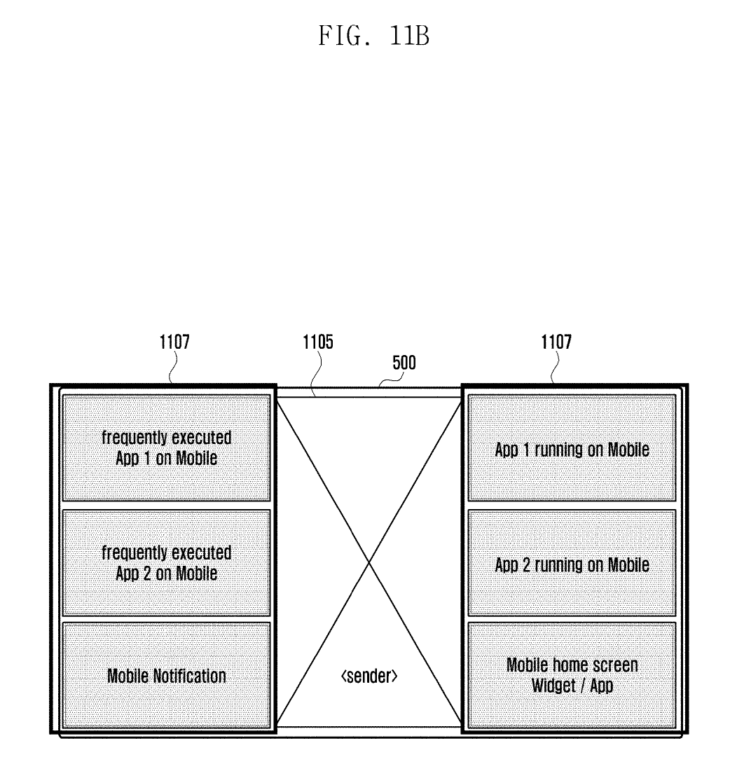

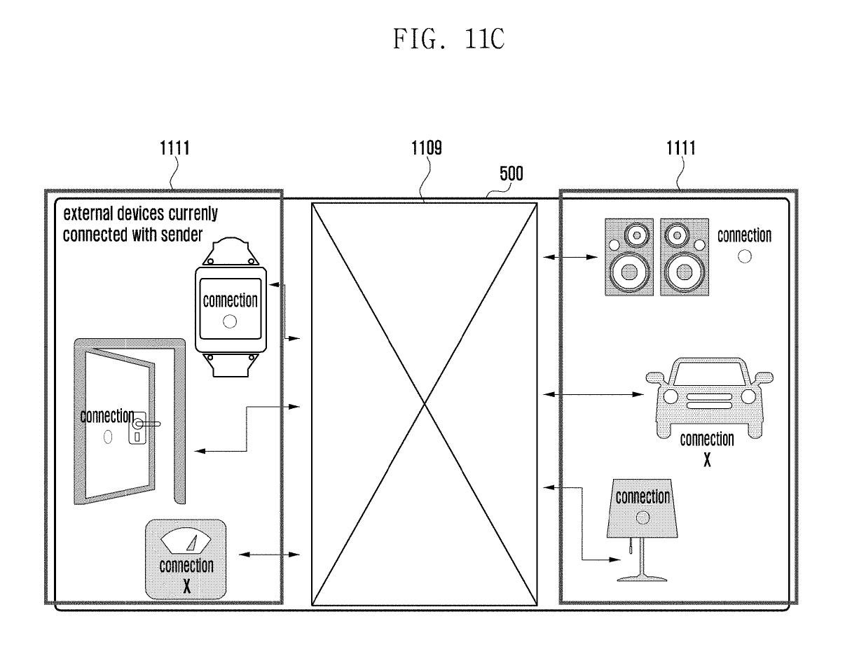

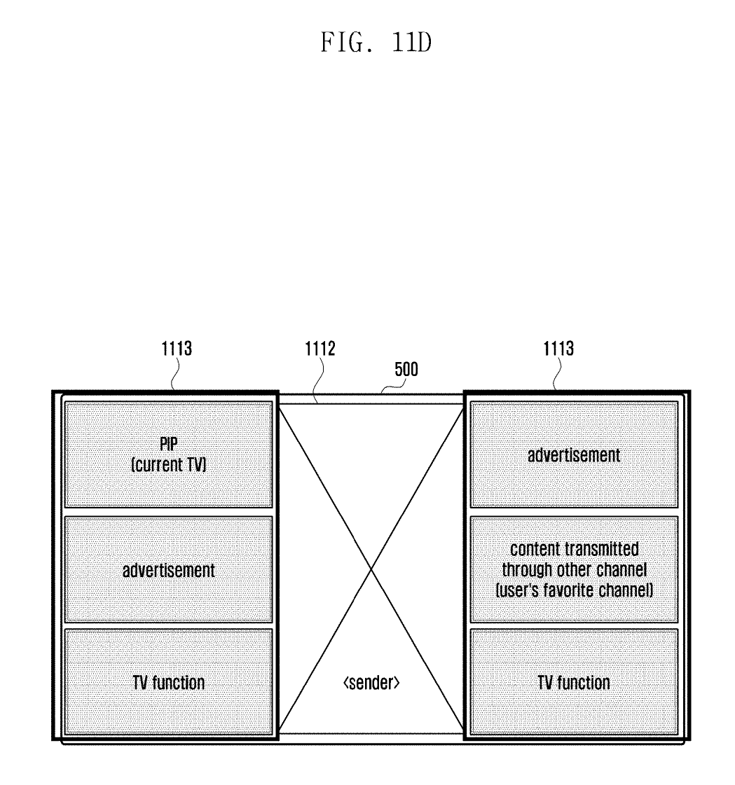

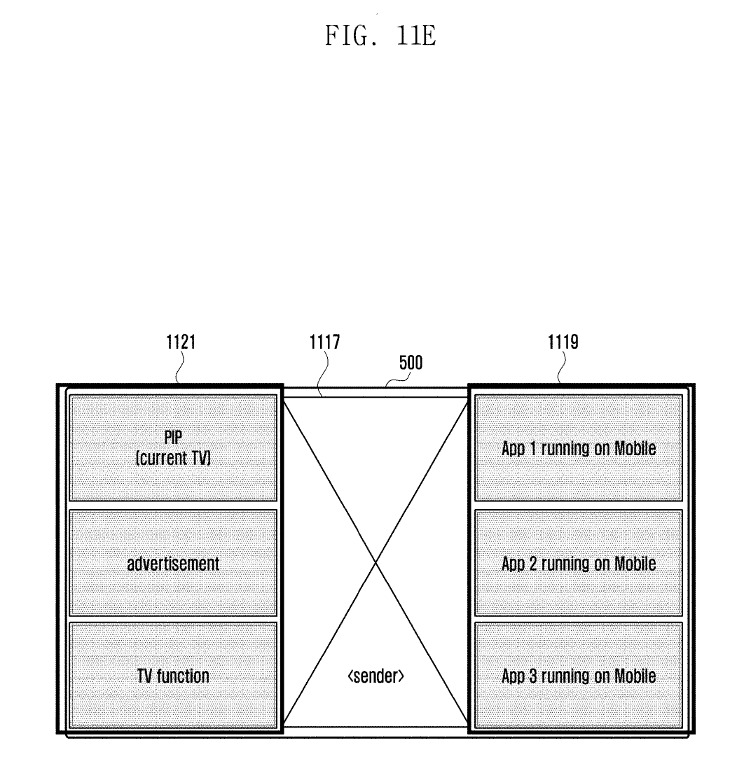

FIGS. 11A to 11E are illustrations of application display on an electronic device according to various embodiments of the present disclosure.

Referring to FIG. 11A, the second electronic device 500 may display independent supplementary information not associated with the second electronic device 500 or the first electronic device 400 in the remaining region of the screen. For example, the second electronic device 500 displays an application window 1101, which presents a mirrored screen image received from the first electronic device 400, in a designated region of the screen, and displays windows 1103 for device-independent information related to weather, advertisement, performing arts, news, stock quotes, and shopping in the remaining region of the screen.

Referring to FIG. 11B, the second electronic device 500 may display, on an application window 1105, supplementary information associated only with the first electronic device 400 in the remaining region of the screen. For example, in the remaining region of the screen, the second electronic device 500 may display windows 1107 for presenting applications running in the background of the first electronic device 400, widgets in the home screen thereof, and applications frequently executed therein.

In one embodiment of the present disclosure, the second electronic device 500 may send the first electronic device 400 an information request for a specific application (e.g. application running in the background or frequently executed application). Upon reception of the information request, the first electronic device 400 may activate the requested application without screen output and send information on the requested application to the second electronic device 500. The second electronic device 500 may display the received application information on the screen.

Referring to FIG. 11C, the second electronic device 500 may receive information on connection states of external devices interworking with the first electronic device 400 from the first electronic device 400, and display the received information on connection states in the remaining region of the screen. For example, the second electronic device 500 may display an application window 1109, which presents a mirrored screen image received from the first electronic device 400, in a designated region of the screen, and display image items 1111 representing connection states of external devices interworking with the first electronic device 400 in the remaining region of the screen.

Referring to FIG. 11D, the second electronic device 500 may display an application window 1112, which presents a mirrored screen image received from the first electronic device 400, in a designated region of the screen, and display windows 1113 for supplementary information associated with the second electronic device 500 in the remaining region of the screen. For example, when the second electronic device 500 is a TV, the second electronic device 500 may display windows for currently viewed TV broadcast, preferred channels, advertisements, and TV control functions in the remaining region of the screen.

Referring to FIG. 11E, the second electronic device 500 may display an application window 1117 and display windows 1119 and 1121 for supplementary information associated with the second electronic device 500 and the first electronic device 400 in the remaining region of the screen. For example, assume that the second electronic device 500 is a TV and the remaining region of the screen is split into multiple sections. As indicated in window 1121, a first section may be used for a window for currently viewed TV broadcast and a second section may be used for a window for TV control functions. As indicated in window 1119, some other sections may be used for windows for applications running in the background of the first electronic device 400.

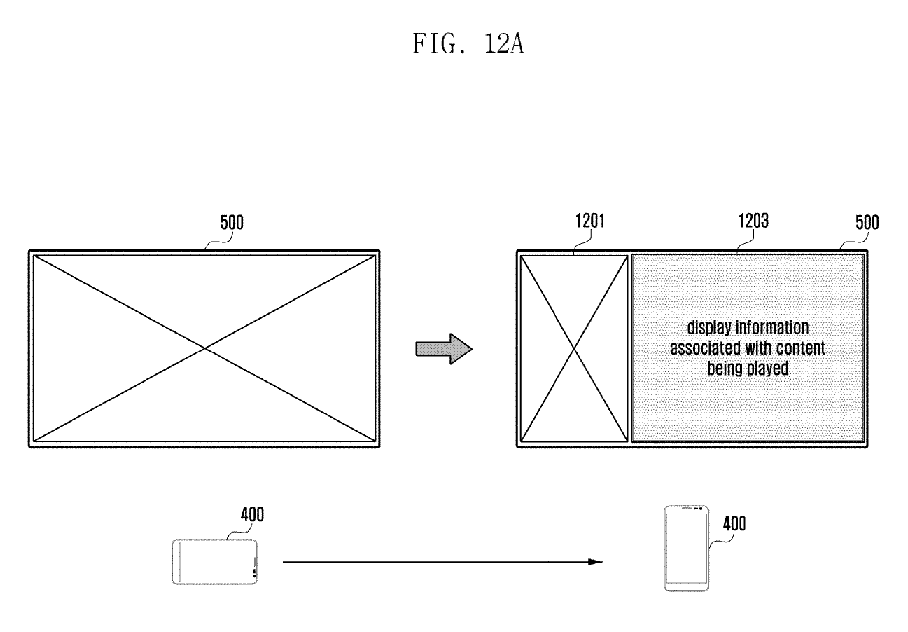

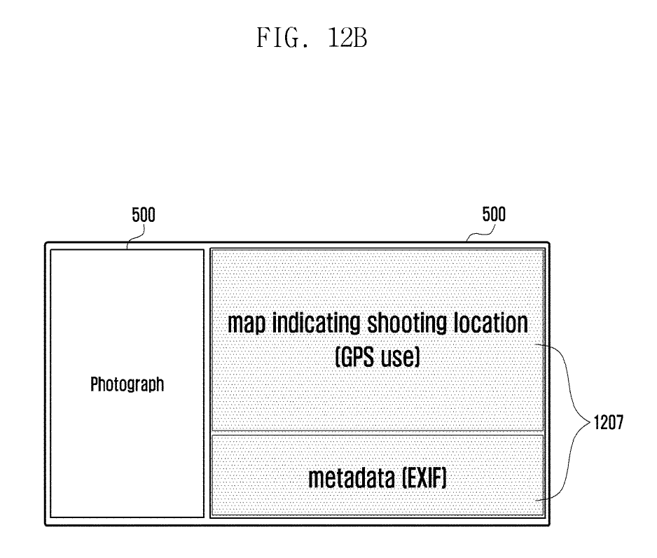

FIGS. 12A and 12B illustrate application display on an electronic device according to various embodiments of the present disclosure.

Referring to FIG. 12A, the second electronic device 500 may display an application window for a mirrored screen image received from the first electronic device 400 operating in landscape mode. Here, for example, the application window may be used to present a photograph, movie, song, or game.

When the first electronic device 400 switches its display mode to portrait mode, the second electronic device 500 may change the arrangement of application windows on the screen correspondingly. For example, the second electronic device 500 may replace the full-screen window with a smaller window in a region 1201 of the screen, and display information related to contents of the window displayed in the region 1201 in the remaining region 1203.

Referring to FIG. 12B, the second electronic device 500 may display information related to contents of an application window displayed in a region 1205 of the screen in the remaining region 1207. For example, when a photograph is displayed in the region 1205, a map indicating the shooting location of the photograph and metadata thereof may be displayed in the remaining region 1207. As another example, when a movie scene is displayed in the region 1205, supplementary information of the movie (e.g. rating, characters, related images, list of stored movies, and installed movie applications) in the remaining region 1207.

Additionally, when a window for a music player is displayed in the region 1205 of the screen, a music video and information regarding music channels, speakers attached to the second electronic device 500 and volume control functions may be displayed in the remaining region 1207. When a window for a game is displayed in the region 1205 of the screen, an image related to the game and a list of games stored in the second electronic device 500 may be displayed in the remaining region 1207.

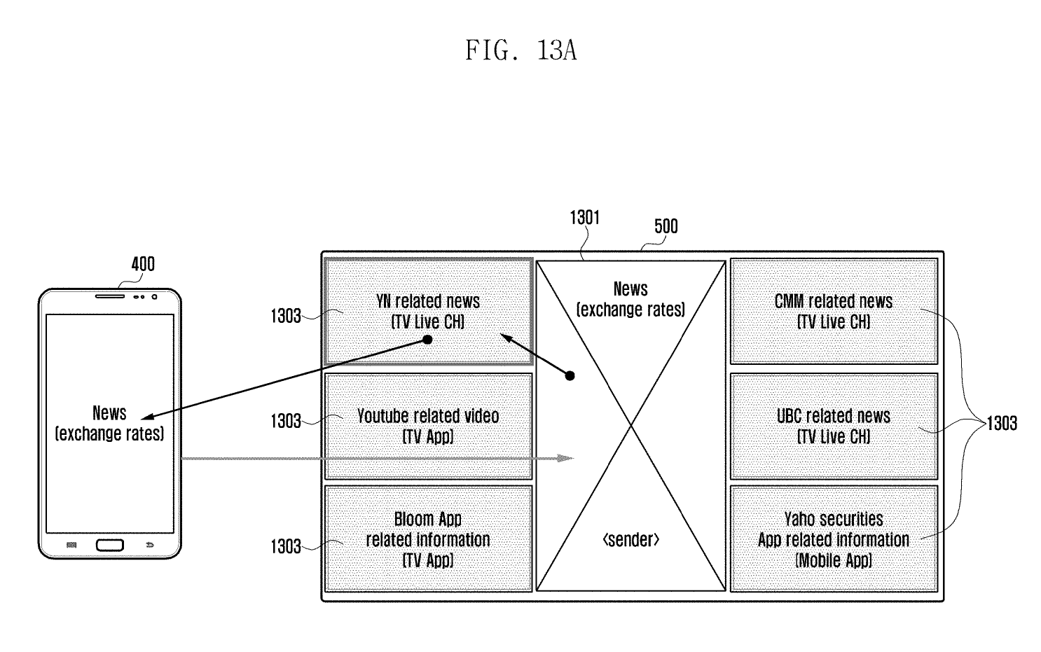

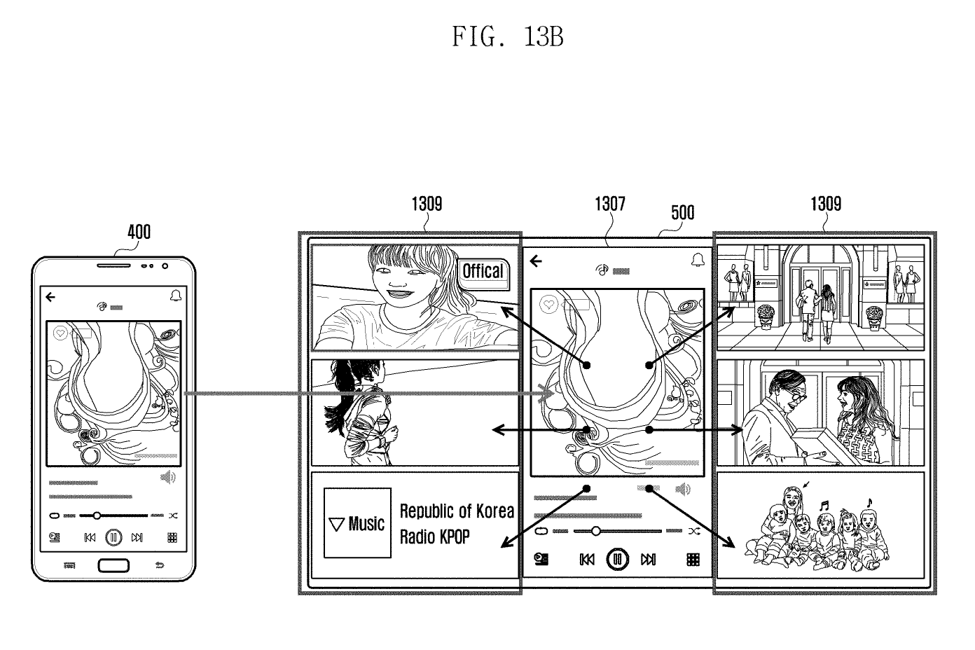

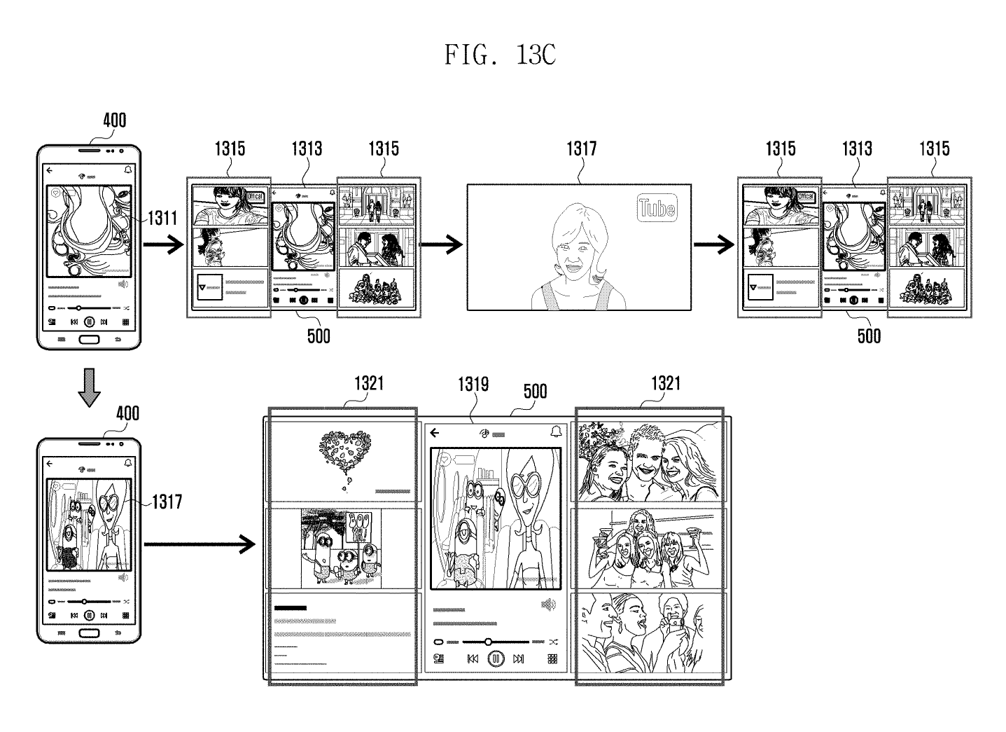

FIGS. 13A to 13C are illustrations of application display on electronic devices according to various embodiments of the present disclosure.

Referring to FIG. 13A, the first electronic device 400 and the second electronic device 500 may exchange data about application display. For example, the first electronic device 400 may display a window for a news application. The second electronic device 500 may display a window 1301 for the news application in a designated region of the screen and display windows 1303 for contents related to the news application in the remaining region of the screen.

The second electronic device 500 may receive an input signal for selecting an application for a window 1303 displayed in a section of the remaining region. Upon reception of the input signal, the second electronic device 500 may display the selected application for the window 1303 in the full-screen format. Alternatively, upon reception of the input signal, the second electronic device 500 may send a request to the first electronic device 400 to replace the application associated with the window 1301 for a mirrored screen image with the application associated with the selected application window 1303.

Referring to FIG. 13B, the first electronic device 400 and the second electronic device 500 may exchange data about application display. For example, the first electronic device 400 may display a window 1305 for a music application. The second electronic device 500 may display a window 1307 for the music application in a designated region of the screen and display windows 1309 for contents related to the music application in the remaining region of the screen. For example, when the second electronic device 500 is a TV, it may display content lists, favorite channels, and favorite channel descriptions in the remaining region of the screen.

Referring to FIG. 13C, the first electronic device 400 may display a window 1311 for a music application. The second electronic device 500 may display a window 1313 for the music application in a designated region of the screen and display windows 1315 for supplementary information related to the music application (e.g. moving image, sound source, channels of the second electronic device 500) in the remaining region of the screen. The second electronic device 500 may receive an input signal for selecting an application window displayed in the remaining region. Upon reception of the input signal, the second electronic device 500 may display the selected application window in the full-screen format as indicated by indicia 1317. Upon reception of a specific key input (e.g. “back” key), the second electronic device 500 may restore the pervious screen.

When a change occurs at the window displayed on the first electronic device 400, the second electronic device 500 may change the window for a mirrored screen image. For example, when a new song is played back in the first electronic device 400 as indicated by indicia 1317, the second electronic device 500 may display a window for an enlarged mirrored screen image in the designated region of the screen as indicated by indicia 1319, and display windows for supplementary information related to the currently played song in the remaining region of the screen as indicated by indicia 1321.

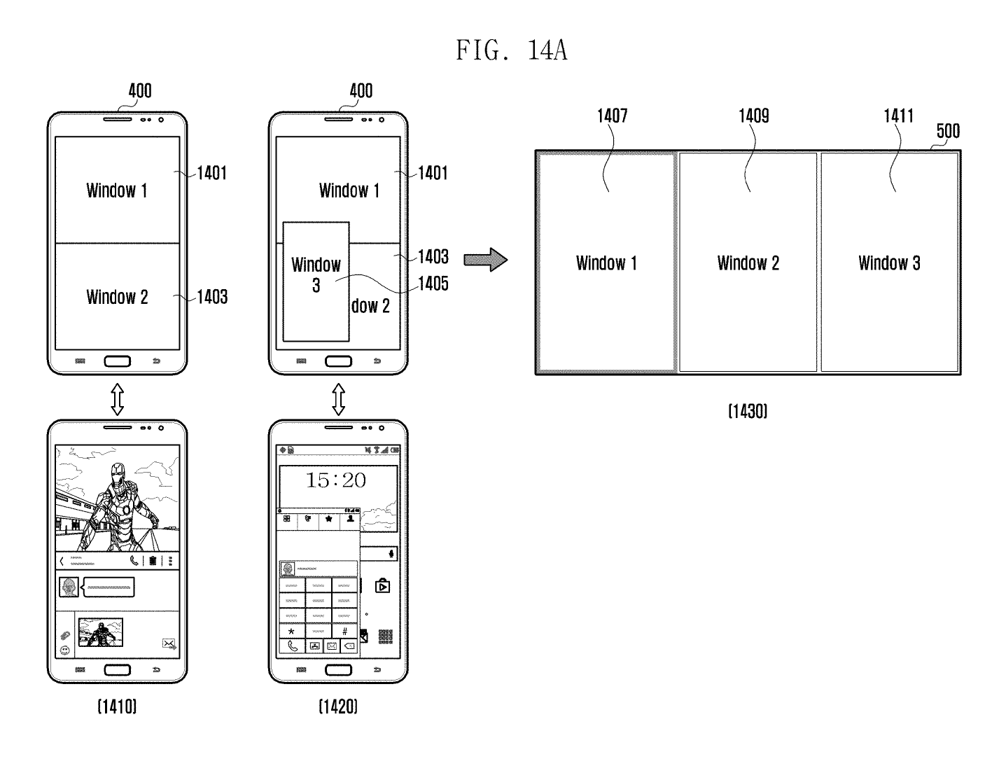

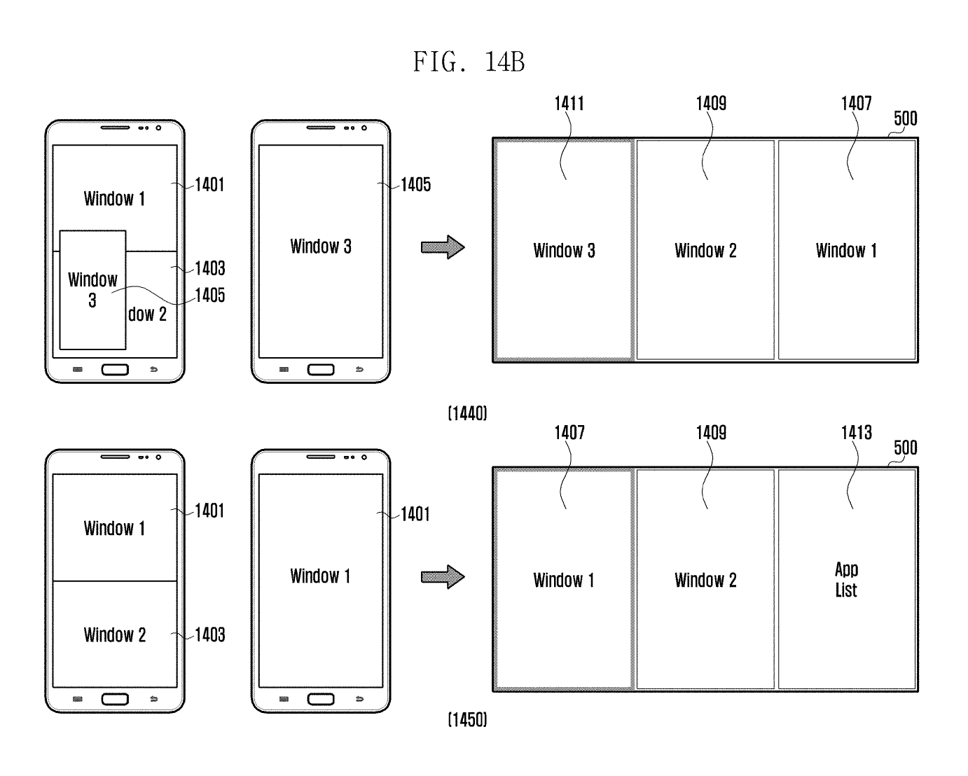

FIGS. 14A and 14B are illustrations of application display on electronic devices according to various embodiments of the present disclosure.

Referring to FIG. 14A, as indicated by indicia 1410 and 1420, the first electronic device 400 may display windows 1401, 1403 and 1405 for different applications on the screen. As indicated by indicia 1430, to display multiple application windows in accordance with those windows displayed on the first electronic device 400, the second electronic device 500 may determine the arrangement of application windows on the screen. For example, the second electronic device 500 may arrange application windows 1407, 1409 and 1411 from the left to the right on the screen.

Referring to FIG. 14B, as indicated by indicia 1440 and 1450, the first electronic device 400 may display windows 1401, 1403 and 1405 for different applications on the screen. To display multiple application windows in accordance with those windows displayed on the first electronic device 400, the second electronic device 500 may determine the arrangement of application windows on the screen. For example, the second electronic device 500 may arrange application windows 1411, 1409 and 1407 from the left to the right on the screen.

When there are multiple overlapping windows, the second electronic device 500 may place the topmost window at the leftmost side of the screen. When there are multiple non-overlapping windows, the second electronic device 500 may place the largest window (in terms of size or resolution) at the leftmost side of the screen, and may also include a window 1413 showing an App List, as shown in FIG. 14B. When there are multiple windows, the second electronic device 500 may determine the arrangement of the windows on the screen on the basis of the creation time of the corresponding application content.

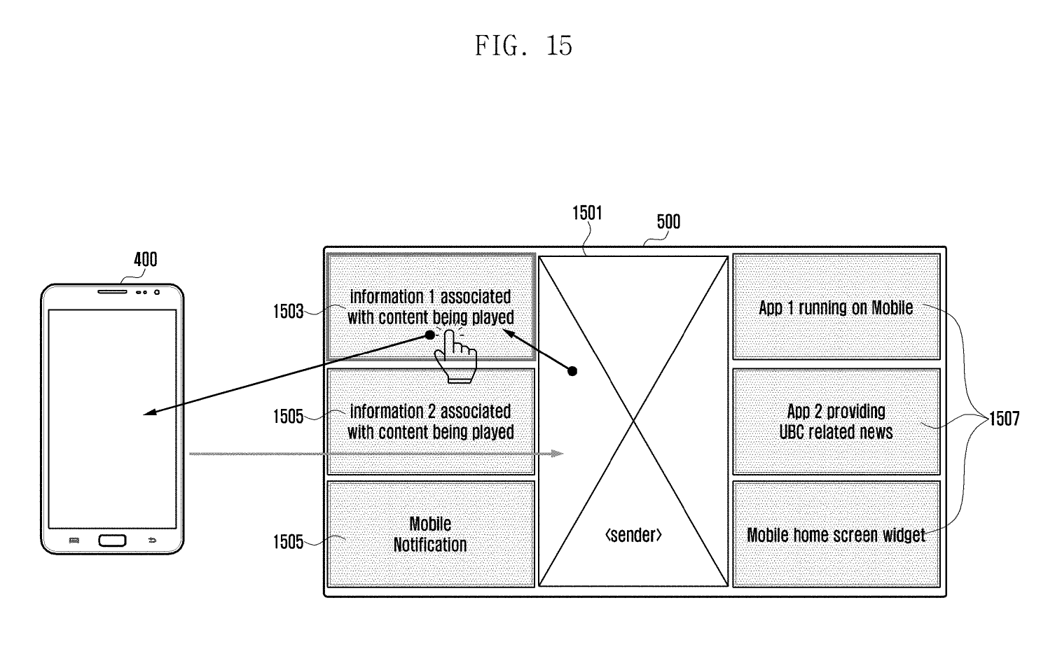

FIG. 15 illustrates application display on an electronic device according to various embodiments of the present disclosure.

Referring to FIG. 15, the second electronic device 500 may display an application window 1501, which presents a mirrored screen image received from the first electronic device 400, in a designated region of the screen, and display supplementary information 1503 and 1505 related to the first electronic device 400 in the remaining region of the screen. Upon reception of an input signal for selecting an application window 1507 displayed in the remaining region of the screen, the second electronic device 500 may display the selected application window in the full-screen format. Additionally, upon reception of the input signal, the second electronic device 500 may send a request to the first electronic device 400 to replace the application whose window is displayed on the screen.

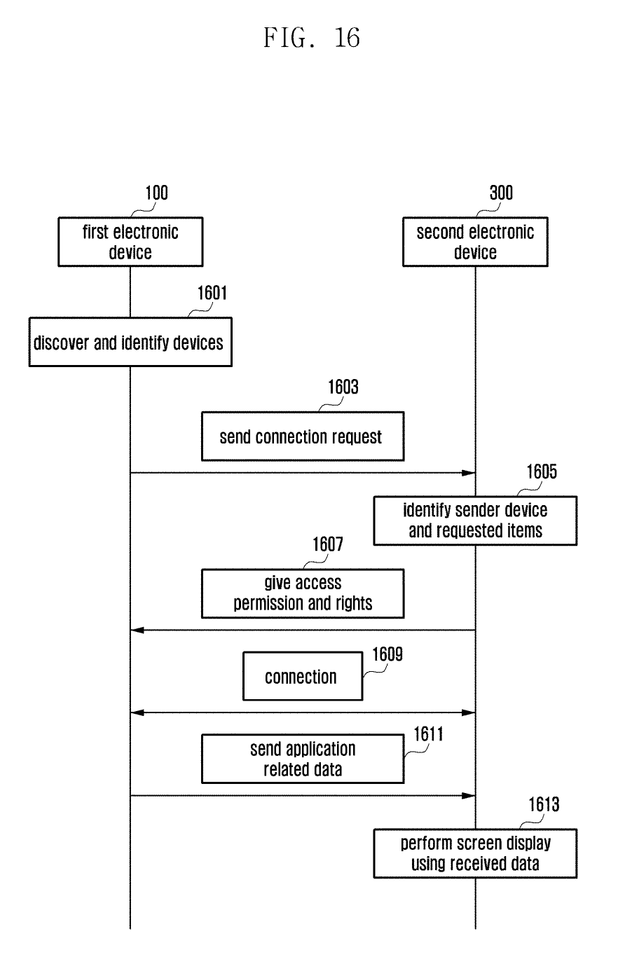

FIG. 16 is a sequence diagram illustrating application display between electronic devices according to various embodiments of the present disclosure.

Referring to FIG. 16, at operation 1601, the first electronic device 400 discovers and identifies external devices. The first electronic device 400 may discover external devices supporting networked communication (e.g. Wi-Fi direct). Here, Wi-Fi direct refers to a communication scheme enabling devices to communicate with each other without requiring separate equipment like an AP or router.

At operation 1603, the first electronic device 400 sends a connection request to a discovered external device (second electronic device 500). At operation 1605, the second electronic device 500 identifies the sending device and examines the request. At operation 1607, the second electronic device 500 sends a response indicating access permission and right to the first electronic device 400.

The first electronic device 400 and the second electronic device 500 may perform connection setup, and perform capability exchange and negotiation. For example, the first electronic device 400 and the second electronic device 500 may exchange information regarding supported codecs, codec profiles, codec levels, and resolutions with each other. Data exchange may be performed by using messages based on an RTSP. For example, data transmission between the first electronic device 400 and the second electronic device 500 may be performed through application mirroring (e.g. full minoring or app minoring).

At operation 1609, the first electronic device 400 is connected with the second electronic device 500.

At operation 1611, the first electronic device 400 sends application related data to the second electronic device 500. For example, the first electronic device 400 may stream screen data of an application to the second electronic device 500.

At operation 1613, the second electronic device 500 displays the received application related data on the screen. For example, the second electronic device 500 may display an application window for a mirrored screen image received from the first electronic device 400 in a designated region of the screen, and display supplementary information associated with the application window or with the electronic devices 400 and 500 in another region of the screen.

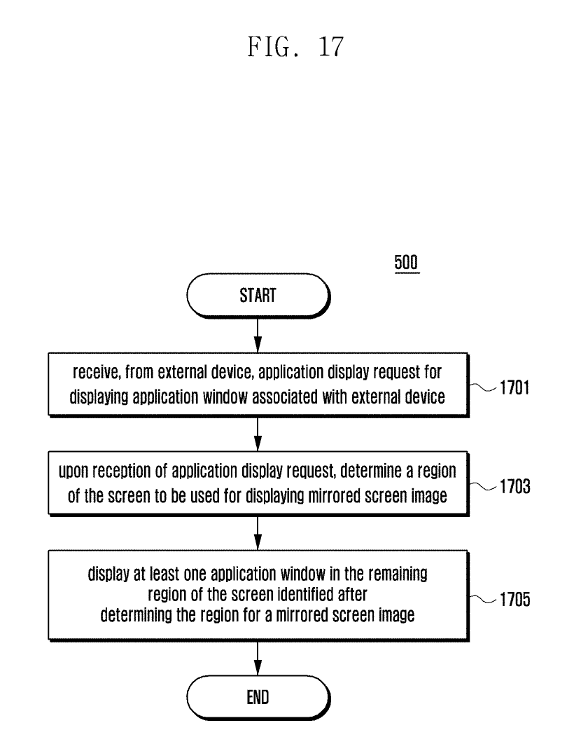

FIG. 17 is a flowchart for application display on an electronic device according to various embodiments of the present disclosure.

Referring to FIG. 17, at operation 1701, the second electronic device 500 receives, from an external device (e.g. first electronic device 400), an application display request for displaying an application window associated with the external device. The first electronic device 400 and the second electronic device 500 may be connected together through short-range wireless communication (e.g. Wi-Fi direct). For example, the second electronic device 500 may receive, from the first electronic device 400, an application display request for displaying a mirrored screen image associated with an application running on the first electronic device 400.

At operation 1703, upon reception of the application display request, the second electronic device 500 determines a region of the screen to be used for displaying a mirrored screen image. The second electronic device 500 may determine a designated region of the screen to be used for displaying a mirrored screen image on the basis of information pre-stored or received from the first electronic device 400.

In one embodiment of the present disclosure, when the external device (e.g. first electronic device 400) is connected, the second electronic device 500 may identify the remaining region of the screen by excluding the region assigned to the window for displaying a mirrored screen image on the basis of pre-stored screen information of external devices.

In one embodiment of the present disclosure, when the external device (e.g. first electronic device 400) is connected, the second electronic device 500 may identify a region of the screen whose screen property does not change for a given time or more as the remaining region.

At operation 1705, the second electronic device 500 displays at least one application window in the remaining region of the screen after determining the region for a mirrored screen image. The second electronic device 500 may display at least one application window in the remaining region of the screen on the basis of at least one of network status information, application activation information, and operating system (OS) information of the second electronic device 500.

In one embodiment of the present disclosure, the second electronic device 500 may display at least one application window in the remaining region of the screen in response to a user input signal for application display. For example, the second electronic device 500 may display application content unrelated with the second electronic device 500 or the external device (e.g. first electronic device 400) in the remaining region of the screen. The second electronic device 500 may display application content related only to the second electronic device 500 in the remaining region of the screen. The second electronic device 500 may display application content related only to the external device (e.g. first electronic device 400) in the remaining region of the screen. The second electronic device 500 may display application content related to the second electronic device 500 and the external device (e.g. first electronic device 400) in the remaining region of the screen.

In one embodiment of the present disclosure, the second electronic device 500 may display information related to application content displayed in the designated region of the screen in the remaining region. For example, when a window for a music application is displayed in the designated region, the second electronic device 500 may display a window for music chart ranking and music video related to the currently played music in the remaining region of the screen.

In one embodiment of the present disclosure, the second electronic device 500 may receive an input event for selecting a window displayed in the remaining region of the screen and send an application display request corresponding to the received input event to the external device (e.g. first electronic device 400). Here, the input event may be related to arrangement or update of application windows displayed in the remaining region of the screen.

In one embodiment of the present disclosure, the second electronic device 500 may receive an input signal from at least one of a connected external input unit and the external device (e.g. first electronic device 400) for changing the application window displayed in the designated region of the screen or at least one application window displayed in the remaining region. Upon reception of a change input signal, the second electronic device 500 may change the arrangement of at least one application window displayed on the screen.

In one embodiment of the present disclosure, when there are multiple application windows to be displayed according to a request signal, the second electronic device 500 may determine the screen layout on the basis of information regarding the window arrangement, screen size and application states in the external device (e.g. first electronic device 400), and display the multiple application windows according to the determined screen layout.

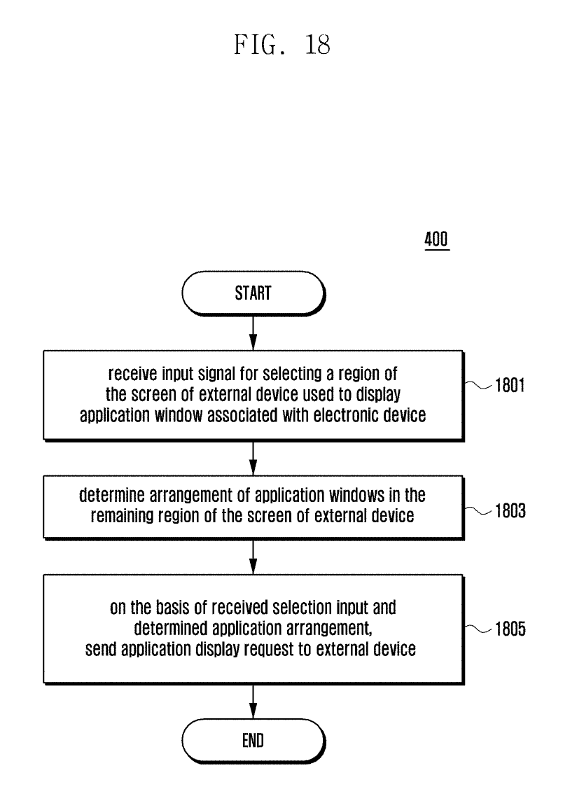

FIG. 18 is a flowchart for application display on an electronic device according to various embodiments of the present disclosure.

Referring to FIG. 18, at operation 1801, the first electronic device 400 receives an input signal for selecting a region of the screen of an external device (e.g. second electronic device 500) used to display an application window associated with the first electronic device 400.

At operation 1803, the first electronic device 400 determines the arrangement of application windows in the remaining region of the screen of the second electronic device 500. The first electronic device 400 may determine the arrangement of application windows according to user input.

In one embodiment of the present disclosure, for an application window to be displayed in the remaining region of the screen, the first electronic device 400 may receive an input for selecting an application whose content is not associated with the first electronic device 400 or the external device (e.g. second electronic device 500). For an application window to be displayed in the remaining region of the screen, the first electronic device 400 may receive an input for selecting an application whose content is associated only with the first electronic device 400. For an application window to be displayed in the remaining region of the screen, the first electronic device 400 may receive an input for selecting an application whose content is associated only with the external device (e.g. second electronic device 500). For the remaining region of the screen, the first electronic device 400 may receive an input for selecting an application whose content is associated with both the first electronic device 400 and the external device (e.g. second electronic device 500).

In one embodiment of the present disclosure, the first electronic device 400 may determine the arrangement of application windows on the basis of at least one of application execution states and background screen information of the first electronic device 400.

At operation 1805, on the basis of the received selection input and determined application arrangement, the first electronic device 400 sends an application display request to the external device (e.g. second electronic device 500).

In one embodiment of the present disclosure, the first electronic device 400 may receive an input signal for controlling the arrangement of application windows displayed on the external device (e.g. second electronic device 500). Upon reception of the input signal, the first electronic device 400 may send an application arrangement adjustment request to the external device (e.g. second electronic device 500).

In one embodiment of the present disclosure, from the external device (e.g. second electronic device 500) having detected an input event on an application window displayed in the remaining region of the screen, the first electronic device 400 may receive a request signal for displaying an application window corresponding to the input event on the screen of the first electronic device 400. Upon reception of the request signal, the first electronic device 400 may display a window of an application corresponding to the input event on the screen thereof.

In one embodiment of the present disclosure, the first electronic device 400 may receive information regarding currently displayed application windows from the external device (e.g. second electronic device 500), and compose a background screen of the first electronic device 400 on the basis of the received information. In one embodiment of the present disclosure, the first electronic device 400 may receive an input signal for changing an application belonging to the background screen of the first electronic device 400, and send an application change request to the external device (e.g. second electronic device 500) on the basis of the received input signal.

According to various embodiments of the present disclosure, a method of application display for an electronic device may include: receiving, from an external device, an application display request for displaying a window for an application associated with the external device; determining, upon the receiving of the application display request, a designated region of a screen to be used for a window presenting a mirrored screen image of the application; and displaying at least one application window in a remaining region of the screen identified after the determining of the designated region of the screen to be used for the window presenting the mirrored screen image of the application. The method may further include at least one of: identifying, when the external device is connected, the remaining region of the screen by excluding the region assigned to the window for a mirrored screen image on a basis of pre-stored screen information of external devices; and/or identifying, when the external device is connected, a region of the screen whose display property does not change for a given time or more as the remaining region. The method may further include: receiving an input signal from at least one of an external input unit connected to the electronic device and the external device for changing the application window displayed in the designated region of the screen or at least one application window displayed in the remaining region; and changing, upon reception of the change input signal, the arrangement of at least one application window displayed on the screen. The displaying of at least one application window in the remaining region may include one of: displaying at least one application window in the remaining region of the screen on a basis of at least one of network status information, application activation information, and operating system (OS) information of the electronic device; and/or displaying at least one application window in the remaining region of the screen in response to a user input signal for application display. The displaying of at least one application window in the remaining region may include one of: displaying a window for application content unrelated with the electronic device or the external device in the remaining region; displaying a window for application content related only to the electronic device in the remaining region; displaying a window for application content related only to the external device in the remaining region; and/or displaying a window for application content related to both the electronic device and the external device in the remaining region. The displaying of at least one application window in the remaining region may include displaying information related to application content of the window displayed in the designated region of the screen in the remaining region. The method may further include: receiving an input event for selecting a window displayed in the remaining region of the screen; and sending an application display request corresponding to the received input event to the external device. The method may further include: determining, when there are multiple application windows to be displayed according to the application display request, a screen layout on a basis of information regarding the window arrangement, screen size and application states in the external device; and displaying the multiple application windows according to the determined screen layout.

According to various embodiments of the present disclosure, a method of application display for an electronic device may include: receiving an input signal for selecting a region of a screen of an external device to be used for displaying an application window associated with the electronic device; determining an arrangement of application windows in a remaining region of the screen of the external device; and sending, on a basis of the received input signal and the determined arrangement of the application window, an application display request to the external device. The determining of the arrangement of application windows in the remaining region may include receiving user input for window arrangement. The receiving of user input for window arrangement may include receiving, for an application window to be displayed in the remaining region of the screen, user input for selecting an application whose content is not associated with the electronic device or the external device, selecting an application whose content is associated only with the electronic device, selecting an application whose content is associated only with the external device, and/or selecting an application whose content is associated with both the electronic device and the external device. The determining of the arrangement of application windows in the remaining region may include determining the arrangement of application windows on a basis of at least one of application execution states and background screen information of the electronic device. The method may further include: receiving an input signal for controlling the arrangement of application windows displayed on the external device; and sending, upon reception of the input signal, an application arrangement adjustment request to the external device. The method may further include: receiving, from the external device having detected an input event on an application window displayed in the remaining region of the screen, a request signal for displaying an application window corresponding to the input event on the screen of the electronic device; and displaying, upon reception of the request signal, a window for an application indicated by the input event on the screen of the electronic device. The method may further include: receiving, from the external device, information regarding currently displayed application windows on the external device; and composing a background screen of the electronic device on a basis of the received information. The method may further include: receiving an input signal for changing an application belonging to the background screen of the electronic device; and sending an application change request to the external device on a basis of the received input signal.

According to various embodiments of the present disclosure, a computer-readable storage medium may store program instructions that, when executed, cause an electronic device to receive, from an external device, an application display request for displaying a window for an application associated with the external device, to determine, upon reception of the application display request, a designated region of the screen to be used for a window presenting a mirrored screen image of the application, and to display at least one application window in the remaining region of the screen identified after determining the region for a mirrored screen image.

According to various embodiments of the present disclosure, a computer-readable storage medium may store program instructions that, when executed, cause an electronic device to receive an input signal for selecting a region of the screen of an external device to be used for displaying an application window associated with the electronic device, to determine the arrangement of application windows in the remaining region of the screen of the external device, and to send, on the basis of the received input signal and determined application arrangement, an application display request to the external device.

In the description, the word “module” may refer to a software component, a hardware component, a firmware component or a combination thereof. “Module” may be used interchangeably with “unit”, “logic”, “logical block”, “component”, “circuit” or the like. A module may be a smallest element or a part thereof acting as a single entity. A module may be a smallest element or a part thereof supporting one or more functions. A module may be implemented mechanically or electronically. For example, a module having a specific function may be implemented using at least one of an Application-Specific Integrated Circuit (ASIC), a Field-Programmable Gate Array (FPGA) and a Programmable-Logic Device (PLD). The apparatus and method of the present disclosure may be implemented at least partially as instructions stored in various computer readable storage media (e.g. memory 130). When the instructions are executed by a processor (e.g. processor 120), the corresponding function is carried out. The computer readable storage media may store program instructions, data files, data structures, and combinations thereof. The instructions may include instructions developed specifically for the present disclosure and existing general-purpose instructions. The computer readable storage media may include magnetic media such as a hard disk and floppy disk, optical media such as a compact disc ROM (CD-ROM) and DVD, magneto-optical media such as a floptical disk, and memory devices such as a ROM, RAM and flash memory. The program instructions may include machine codes produced by compilers and high-level language codes executable through interpreters. In various embodiments of the present disclosure, an existing component like a module may be omitted, a new component may be added, or an existing component may be replaced by a similar component with a different name Operations supported by components may be carried out in sequence, in parallel, by repetition, or heuristically. One operation may be skipped or a new operation may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a transceiver;
a display; and
one or more processor,
wherein the one or more processor is configured to:
receive, from an external device, an application display request for displaying a window for an application associated with the external device,
determine, upon the receiving of the application display request, a designated region of a screen to be used for a window presenting a mirrored screen image of the application on the display, and
display at least one application window in a remaining region of the screen identified after the determining of the designated region of the screen to be used for the window presenting the mirrored screen image of the application.

2. The electronic device of claim 1, wherein, when the external device is connected, the one or more processor is further configured to:
identify the remaining region of the screen by excluding the region designated to the window for a mirrored screen image on the basis of pre-stored screen information of external devices, or
identify a region of the screen whose display property does not change for a given time or more as the remaining region.

3. The electronic device of claim 1, wherein the one or more processor is further configured to:
receive an input signal from at least one of an external input device connected to the electronic device and the external device for changing the application window displayed in the designated region of the screen or at least one application window displayed in the remaining region, and
change, upon reception of the change input signal, an arrangement of at least one application window displayed on the screen.

4. The electronic device of claim 1, wherein the one or more processor is further configured to:
display at least one application window in the remaining region of the screen on a basis of at least one of network status information, application activation information, and operating system (OS) information of the electronic device, or
display at least one application window in the remaining region of the screen in response to a user input signal for application display.

5. The electronic device of claim 4, wherein the one or more processor is further configured to:
display a window for application content unrelated to the electronic device or the external device in the remaining region,
display a window for application content related only to the electronic device in the remaining region,
display a window for application content related only to the external device in the remaining region, or
display a window for application content related to both the electronic device and the external device in the remaining region.

6. The electronic device of claim 1, wherein the one or more processor is further configured to display information related to application content of the window displayed in the designated region of the screen in the remaining region.

7. The electronic device of claim 1, wherein the one or more processor is further configured to:
receive an input event for selecting a window displayed in the remaining region of the screen, and
send an application display request corresponding to the received input event to the external device.

8. The electronic device of claim 1, wherein, when there are multiple application windows to be displayed according to the application display request, the one or more processor is further configured to:
determine a screen layout on a basis of information regarding window arrangement, screen size and application states in the external device, and
display the multiple application windows according to the determined screen layout.

9. An electronic device comprising:
a transceiver;
a display; and
one or more processor configured to:
perform a process of receiving an input signal for selecting a region of a screen of an external device to be used for displaying an application window associated with the electronic device,
determine an arrangement of application windows in a remaining region of the screen of the external device, and
control the transceiver to send, on a basis of the received input signal and the determined arrangement of the application windows, an application display request to the external device.

10. The electronic device of claim 9, wherein, for an application window to be displayed in the remaining region of the screen, the one or more processor is further configured to receive user input for at least one of:
selecting an application whose content is not associated with the electronic device or the external device,
selecting an application whose content is associated only with the electronic device,
selecting an application whose content is associated only with the external device, or
selecting an application whose content is associated with both the electronic device and the external device.

11. The electronic device of claim 9, wherein the one or more processor is further configured to determine the arrangement of application windows on a basis of at least one of application execution states and background screen information of the electronic device.

12. The electronic device of claim 9, wherein the one or more processor is further configured to:
receive an input signal for controlling the arrangement of application windows displayed on the external device, and
send, upon reception of the input signal, an application arrangement adjustment request to the external device.

13. The electronic device of claim 9, wherein the one or more processor is further configured to:
receive, from the external device having detected an input event on an application window displayed in the remaining region of the screen, a request signal for displaying an application window corresponding to the input event on the screen of the electronic device, and
display, upon reception of the request signal, a window for an application indicated by the input event on a screen of the electronic device.

14. A method of displaying an application for an electronic device, the method comprising:
receiving, from an external device, an application display request for displaying a window for an application associated with the external device;
determining, upon the receiving of the application display request, a designated region of a screen to be used for a window presenting a mirrored screen image of the application; and
displaying at least one application window in a remaining region of the screen identified after the determining of the designated region of the screen to be used for the window presenting the mirrored screen image of the application.

15. The method of claim 14, further comprising at least one of:
identifying, when the external device is connected, the remaining region of the screen by excluding the region designated to the window for a mirrored screen image on a basis of pre-stored screen information of external devices; or
identifying, when the external device is connected, a region of the screen whose display property does not change for a given time or more as the remaining region.

16. The method of claim 14, further comprising:
receiving an input signal from at least one of an external input device connected to the electronic device and the external device for:
changing the application window displayed in the designated region of the screen or at least one application window displayed in the remaining region, and
changing, upon reception of the change input signal, an arrangement of at least one application window displayed on the screen.

17. The method of claim 14, wherein the displaying of the at least one application window in the remaining region comprises at least one of:
displaying at least one application window in the remaining region of the screen on a basis of at least one of network status information, application activation information, and operating system (OS) information of the electronic device, or
displaying at least one application window in the remaining region of the screen in response to a user input signal for application display.

18. The method of claim 14, wherein the displaying of the at least one application window in the remaining region comprises displaying information related to application content of the window displayed in the designated region of the screen in the remaining region.

19. The method of claim 14, further comprising:
receiving an input event for selecting a window displayed in the remaining region of the screen; and
sending an application display request corresponding to the received input event to the external device.

20. The method of claim 14, further comprising:
determining, when there are multiple application windows to be displayed according to the application display request, a screen layout on a basis of information regarding the window arrangement, screen size and application states in the external device, and
displaying the multiple application windows according to the determined screen layout.
